(19) United States
(12) Patent Application Publication
(10) Pub. No.: US 2023/0108399 A1
(43) Pub. Date: Apr. 6, 2023

(54) Electrophotographic Photoreceptor, Electrophotographic Photoreceptor Cartridge, and Image Formation Device

(71) Applicant: Mitsubishi Chemical Corporation, Tokyo (JP)

(72) Inventor: Daisuke Yamazaki, Tokyo (JP)

(73) Assignee: Mitsubishi Chemical Corporation, Tokyo (JP)

(21) Appl. No.: 17/953,641

(22) Filed: Sep. 27, 2022

Related U.S. Application Data
(63) Continuation of application No. PCT/JP2021/011723, filed on Mar. 22, 2021.

(30) Foreign Application Priority Data
Mar. 30, 2020 (JP) 2020-060641

(51) Int. Cl. G03G 5/147; G03G 5/06; G03G 15/02

(52) U.S. Cl. CPC G03G 5/14704; G03G 5/06142; G03G 15/0216

(57) ABSTRACT

To provide an image formation device that is capable of printing without problems in chargeability, leak resistance, gas resistance, and abrasion resistance, even with a contact charging system, and an electrophotographic photoreceptor and an electrophotographic photoreceptor cartridge used in the image formation device. The problem can be solved by an image formation device of a contact charging system including a positively charging electrophotographic photoreceptor including a single layer photosensitive layer and an over coat layer containing a cured product formed by curing a curable compound.

### TECHNICAL FIELD

The present invention relates to an electrophotographic photoreceptor having a cured protective layer as an over coat layer, an electrophotographic photoreceptor cartridge, and an image formation device, and particularly relates to a so-called single layer type electrophotographic photoreceptor used by positively charging the photoreceptor surface with a contact charger accompanied by a discharge phenomenon, an electrophotographic photoreceptor cartridge, and an image formation device.

### BACKGROUND ART

The electrophotography can produce images with high quality in high speed, and therefore has been widely used in the fields including duplicators, printers, multifunction peripherals, and digital printing. An electrophotographic photoreceptor (which may be hereinafter referred simply to as a “photoreceptor”) as the core part of the electrophotography used has been a photoreceptor that uses an organic photoconductive substance having such advantages as no pollution, easiness in film formation, and easiness in production.

The known organic electrophotographic photoreceptors include, from the standpoint of the layer structure, a single layer type electrophotographic photoreceptor having a charge generating material and a charge transporting material in one layer (which may be hereinafter referred to as a “single layer type photoreceptor”), and a laminate type electrophotographic photoreceptor having a charge generating material and a charge transporting material that are separated and laminated in different layers (i.e., a charge generating layer and a charge transporting layer) (which may be hereinafter referred to as a “laminate type photoreceptor”).

Between these, the laminate type photoreceptor can be easily optimized for the functions of each layer from the standpoint of the design of the photoreceptor, and can be easily controlled for the characteristics thereof, and therefore most of the current photoreceptors are this type. Most of the laminate type photoreceptors have a charge generating layer and a charge transporting layer in this order on a substrate. In the charge transporting layer, there are significantly less kinds of favorable electron transporting materials, whereas many materials having good characteristics as the hole transporting material have been known. Accordingly the laminate type photoreceptor generally has a charge generating layer and a charge transporting layer in this order on a substrate, and is used by negative charging. In the negative charge system, the amount of ozone generated from the charging unit is larger than the positive charge system in which the photoreceptor surface is positively charged, and thereby the deterioration of the photoreceptor therewith may be a problem in some cases.

On the other hand, the single layer type photoreceptor may be used in any of the negative charge system and the positive charge system in principle, but is advantageously applied to the positive charge system since the ozone generation causing a problem in the laminate type photoreceptor can be suppressed, and a higher sensitivity than the negative charge system can be generally obtained. Furthermore, the positively charging single layer type photoreceptor requires less coating steps, and has an advantage in resolution, and accordingly the single layer type photoreceptor has been partly put to practical use, and has been variously investigated and improved up to the present date, although the electric characteristics thereof have some inferior points to the negatively charged laminate type photoreceptor (see PTLs 1 to 5). In charging a photoreceptor, in general, the photoreceptor is rotated multiple times after starting the application of voltage to a charging roller, so as to charge to a target surface potential, and for example, a positively charging single layer type photoreceptor has a problem that the hole transporting material and the electron transporting material tend to bleed out to the photoreceptor surface to cause so-called bleed-out, failing to perform charging readily. Specifically a part of the charge carried on the photoreceptor surface is lost from the surface due to the influence of the component bleeding out, and thereby the rotation number required for achieving the target potential on the photoreceptor surface is increased. This problem impairing the chargeability has been known, and the investigations on the suppression of the problem by adding a particular additive have been made (PTL 6).

In recent years, as a charging means for a photoreceptor in an image formation device, a roller charging system, which generates a less amount of an oxidizing gas, such as ozone, is being preferred rather than such charging systems as corotron and scorotron, from the standpoint of suppressing the influence on the environment. In the roller charging system, a contact roller charging system has been known as being capable of further suppressing the generation of the gas (PTL 7).

### CITATION LIST

### Patent Literatures

PTL 1: JP H5-92936 A
PTL 2: JP H2-228670 A
PTL 3: JP 2001-33997 A
PTL 4: JP 2005-331965 A
PTL 5: JP 2013-231866 A
PTL 6: WO 2017/170615
PTL 7: JP 2012-14142 A

### SUMMARY OF INVENTION

### Technical Problem

Accordingly while the application of the positively charging single layer type photoreceptor to an image formation device of the contact roller charging system has been demanded since the ozone generation can be reduced as much as possible to suppress the influence on the environment, there are many problems in practical realization thereof due to the following factors.

In the positively charging single layer type photoreceptor, as described above, the particular additive has been necessarily added since the hole transporting material and the electron transporting material bleed out to the photoreceptor surface to impair the chargeability. However, the addition of the additive is a cost burden, and furthermore, the addition of the additive, which is generally a low molecular weight component, may impair the abrasion resistance in some cases.

In the case where the photosensitive layer is a single layer type, or in the case where the photosensitive layer in contact with the over coat layer contains the charge generating material (for example, a reversed laminate type photosensitive layer including a charge transporting layer and a charge generating layer laminated in this order), the charge generating material is exposed as an aggregate on the photoreceptor surface, and therefore the electric field is locally concentrated to large protrusions of the aggregate of the charge generating material particularly in the contact roller charging, resulting in an overcurrent flowing in this part, which tends to promote insulation breakdown of the photosensitive layer. Specifically, a pinhole-like leak defect tends to occur on the photoreceptor surface, which is significantly disadvantageous to the leak resistance. In the case where the pinhole-like leak defect occurs on the photoreceptor surface, an overcurrent flows in the defect to cause voltage drop of the electric power source, which results in band-like charge failure over the entire contact width of the charger. Moreover, in the case where a gas, such as ozone, invades the photoreceptor surface, there is also a disadvantage that the charge generating material existing in the vicinity of the surface due to the single layer structure tends to receive the influence thereby.

The deterioration of the chargeability due to the bleed-out does not cause a problem in a photoreceptor used by charging the surface thereof negatively and the leak problem and the low gas resistance due to the charge generating material existing in the vicinity of the surface and exposed do not cause a problem in the case where the ordinary normal laminate type photoreceptor including the charge generating layer and the charge transporting layer laminated in this order is used.

The present invention has been made in view of the aforementioned problems. Specifically an object of the present invention is to provide an image formation device that does not cause the problems described above, and an electrophotographic photoreceptor and an electrophotographic photoreceptor cartridge used in the image formation device.

### Solution to Problem

The present inventors have found that the problems can be solved by an image formation device of a contact charging system, particularly a contact roller charging system, that includes a positively charging electrophotographic photoreceptor including a single layer photosensitive layer and an over coat layer containing a cured product formed by curing a curable compound, such as a photocurable compound. Specifically the substance of the present invention resides in the following.

<1> An image formation device including at least an electrophotographic photoreceptor, the image formation device having a contact charging system as a charging system, the electrophotographic photoreceptor being a positively charging electrophotographic photoreceptor including a single layer photosensitive layer containing at least a binder resin, a charge generating material, a hole transporting material, and an electron transporting material, and an over coat layer containing a cured product formed by curing a curable compound.

<2> The image formation device according to the item <1>, wherein the curable compound is a photocurable compound.

<3> The image formation device according to the item <1> or <2>, wherein the charging system of the image formation device is a contact roller charging system.

<4> An image formation device including at least an electrophotographic photoreceptor, the image formation device having a contact roller charging system as a charging system, the electrophotographic photoreceptor being a positively charging electrophotographic photoreceptor including a single layer photosensitive layer containing at least a binder resin, a charge generating material, a hole transporting material, and an electron transporting material, and an over coat layer containing a cured product formed by curing a photocurable compound.

<5> The image formation device according to any one of the items <1> to <4>, wherein the over coat layer of the electrophotographic photoreceptor contains metal oxide particles.

<6> The image formation device according to the item <5>, wherein a content ratio (mass ratio) of the metal oxide particles of with respect to the curable compound is 0.5 or more.

<7> The image formation device according to any one of the items <1> to <6>, wherein the single layer photosensitive layer contains 30 parts by mass or more of the electron transporting material per 100 parts by mass of the binder resin.

<8> The image formation device according to any one of the items <1> to <7>, wherein the single layer photosensitive layer contains 70 parts by mass or more of the hole transporting material per 100 parts by mass of the binder resin.

<9> The image formation device according to any one of the items <1> to <8>, wherein the single layer photosensitive layer contains 1.0 part by mass or more of the charge generating material per 100 parts by mass of the binder resin.

<10> The image formation device according to any one of the items <1> to <9>, wherein the over coat layer has a thickness of 0.2 μm or more and 6 μm or less.

<11> The image formation device according to any one of the items <1> to <10>, wherein the single layer photosensitive layer contains tribenzylamine.

<12> The image formation device according to any one of the items <1> to <11>, wherein the charging system of the image formation device is a contact charging system applying only a direct current voltage.

<13> An image formation method using an image formation device including at least an electrophotographic photoreceptor, the image formation device including a contact charging device, the electrophotographic photoreceptor including a single layer photosensitive layer containing at least a binder resin, a charge generating material, a hole transporting material, and an electron transporting material, and an over coat layer containing a cured product formed by curing a curable compound, the image formation method including charging positively the electrophotographic photoreceptor, and developing with a developer.

<14> The image formation method according to the item <13>, wherein the curable compound is a photocurable compound.

<15> The image formation method according to the item <13> or <14>, wherein the image formation device has a contact type charging roller.

<16> The image formation method according to any one of the items <13> to <15>, wherein the image formation method includes charging the electrophotographic photoreceptor by applying only a direct current voltage thereto.

<17> The image formation method according to any one of the items <13> to <16>, wherein the image formation method includes charging the electrophotographic photoreceptor to make a charge potential thereof of +600 V or more.

<18> A positively charging electrophotographic photoreceptor used for a contact charging system, the positively charging electrophotographic photoreceptor including a single layer photosensitive layer containing at least a binder resin, a charge generating material, a hole transporting material, and an electron transporting material, and an over coat layer containing a cured product formed by curing a curable compound.

<19> The positively charging electrophotographic photoreceptor according to the item <18>, wherein the curable compound is a photocurable compound.

<20> The positively charging electrophotographic photoreceptor according to the item <18> or <19>, wherein the contact charging system is a contact roller charging system.

<21> A positively charging electrophotographic photoreceptor used for a contact roller charging system, the positively charging electrophotographic photoreceptor including a single layer photosensitive layer containing at least a binder resin, a charge generating material, a hole transporting material, and an electron transporting material, and an over coat layer containing a cured product formed by curing a photocurable compound.

<22> An electrophotographic photoreceptor cartridge including the electrophotographic photoreceptor according to any one of the items <18> to <21>, and at least one of a charging unit that charges the electrophotographic photoreceptor, an exposing unit that exposes the charged electrophotographic photoreceptor to form an electrostatic latent image, a developing unit that develops the electrostatic latent image formed on the electrophotographic photoreceptor, and a cleaning unit that cleans the electrophotographic photoreceptor.

<23> An image formation device including the electrophotographic photoreceptor according to any one of the items <18> to <21>, a charging unit that charges the electrophotographic photoreceptor, an exposing unit that exposes the charged electrophotographic photoreceptor to form an electrostatic latent image, and a developing unit that develops the electrostatic latent image formed on the electrophotographic photoreceptor.

<24> An image formation device including at least an electrophotographic photoreceptor, the image formation device having a contact charging system as a charging system, the electrophotographic photoreceptor being an electrophotographic photoreceptor including an over coat layer containing a cured product formed by curing a curable compound, and containing a charge generating material in a photosensitive layer in contact with the over coat layer.

### Advantageous Effects of Invention

The image formation device of the present invention is an image formation device capable of printing with no problem in chargeability and leak resistance even by a contact charging system, particularly a contact roller charging system, and an electrophotographic photoreceptor and an electrophotographic photoreceptor cartridge used in the image formation device can be provided.

### BRIEF DESCRIPTION OF DRAWING

FIG. 1 is a schematic illustration showing a structure of a main part of one embodiment of the image formation device of the present invention.

### DESCRIPTION OF EMBODIMENTS

Embodiments of the present invention will be described in detail below, but the present invention is not limited to the description below, and can be practiced with appropriate modifications unless deviating from the substance of the present invention.

<<Electrophotographic Photoreceptor>>

The structure of the electrophotographic photoreceptor of the present invention will be described below. The electrophotographic photoreceptor of the present invention may be used by charging positively or by charging negatively and is preferably used by charging positively since the effects of the present invention can be well enjoyed. Furthermore, the electrophotographic photoreceptor preferably has a structure including a single layer photosensitive layer used by charging positively having thereon an over coat layer.

< Conductive Support>

The conductive support is not particularly limited, and examples thereof mainly used include a metal material such as aluminum, an aluminum alloy a stainless steel, copper, and nickel, a resin material having conductivity imparted with conductive powder, such as a metal, carbon, and tin oxide, added thereto, and a resin, glass, paper, or the like having vapor-deposited or coated on the surface thereof a conductive material, such as aluminum, nickel, and ITO (indium tin oxide). One kind of these materials may be used alone, or two or more kinds thereof may be used as an optional combination at an optional ratio. Examples of the form of the conductive support used include a drum form, a sheet form, and a belt form. A conductive support formed of a metal material having coated thereon a conductive material having a suitable resistance value for controlling the conductivity and the surface property or for covering defects may also be used. In the case where a metal material, such as an aluminum alloy is used as the conductive support, the metal material may be used after forming an anodized film thereon. In the case where an anodized film is formed, a sealing treatment is preferably performed by a known method.

The surface of the conductive support may be smooth, or may be roughed by using a particular cutting method or by subjecting to an abrasive treatment. The surface thereof may also be roughened by mixing particles having a suitable particle diameter in the material constituting the conductive support. A drawn pipe may be directly used with no cutting work, for reducing the cost.

< Undercoating Layer>

An undercoating layer may be provided between the conductive support and the photosensitive layer for the purpose of improving the adhesiveness, the blocking capability and the like, and hiding surface defects of the support. The undercoating layer used may be a resin or a resin having particles, such as metal oxide particles, dispersed therein. The undercoating layer may be formed of a single layer or may include multiple layers.

Examples of the metal oxide particles used in the undercoating layer include metal oxide particles containing one kind of a metal element, such as titanium oxide, aluminum oxide, silicon oxide, zirconium oxide, zinc oxide, and iron oxide, and metal oxide particles containing multiple kinds of metal elements, such as calcium titanate, strontium titanate, and barium titanate. The undercoating layer may contain only one kind of the particles, or may contain multiple kinds of the particles used by mixing. Among the metal oxide particles, titanium oxide and aluminum oxide are preferred, and titanium oxide is particularly preferred. The titanium oxide particles may have a surface that is treated with an inorganic material, such as tin oxide, aluminum oxide, antimony oxide, zirconium oxide, and silicon oxide, or an organic material, such as stearic acid, a polyol, and a silicone. The crystal form of the titanium oxide particles may be any of rutile, anatase, brookite, and amorphous. Multiple kinds of crystal states from these crystal states may be contained.

The metal oxide particles having various particle diameters may be used, and among these, the average primary particle diameter is preferably 10 nm or more and 100 nm or less, and particularly preferably 10 nm or more and 50 nm or less. The average primary particle diameter can be obtained from a TEM photograph or the like.

The undercoating layer is preferably formed in the form containing the metal oxide particles dispersed in a binder resin. Examples of the binder resin used in the undercoating layer include known binder resins, for example, an epoxy resin, a polyethylene resin, a polypropylene resin, an acrylic resin, a methacrylic resin, a polyamide resin, a vinyl chloride resin, a vinyl acetate resin, a phenol resin, a polycarbonate resin, a polyurethane resin, a polyimide resin, a polyvinylidene chloride resin, a polyvinyl acetal resin, a vinyl chloride-vinyl acetate copolymer, a polyvinyl alcohol resin, a polyacrylic resin, a polyacrylamide resin, a polyvinylpyrrolidone resin, a polyvinylpyridine resin, a water soluble polyester resin, a cellulose ester resin, such as nitrocellulose, a cellulose ether resin, casein, gelatin, polyglutamic acid, starch, starch acetate, amino starch, an organic zirconium compound, such as a zirconium chelate compound and a zirconium alkoxide compound, an organic titanyl compound, such as a titanyl chelate compound and a titanium alkoxide compound, and a silane coupling agent. The materials may be used alone, or two or more kinds thereof may be used by mixing as an optional combination at an optional ratio. These materials may be used in the form that is cured with a curing agent. Among these, a copolymer polyamide, a modified polyamide, and the like, soluble in an alcohol are preferred since good dispersibility and good coatability can be obtained.

In the single layer type photoreceptor of the present invention, in general, the charge generating layer constituting the laminate type photoreceptor may be used as a substitute of the undercoating layer. In this case, a layer obtained by coating a phthalocyanine pigment or an azo pigment dispersed in a binder resin is preferably used since the layer may be excellent in electric characteristics in some cases. Between these, a phthalocyanine pigment (phthalocyanine compound), is more preferably used from the standpoint of the electric characteristics. The binder resin used is preferably a polyvinyl acetal resin, and a polyvinyl butyral resin is particularly preferably used. In this case, oxytitanium phthalocyanine having a clear peak at a diffraction angle 2θ±0.2° of 27.2° in powder X-ray diffraction using CuKα ray is preferably mixed.

The proportion of the particles with respect to the binder resin used in the undercoating layer may be optionally selected, and is generally preferably in a range of 10% by mass or more and 500% by mass or less with respect to the binder resin from the standpoint of the stability and the coatability of the dispersion liquid.

The film thickness of the undercoating layer is optional unless the effects of the present invention are significantly impaired, is generally 0.01 μm or more, and preferably 0.1 μm or more, and is generally 30 μm or less, and preferably 20 μm or less, from the standpoint of enhancing the electric characteristics, the strong exposure characteristics, the image characteristics, the repetition characteristics, and the coatability in production of the electrophotographic photoreceptor. The undercoating layer may contain a known antioxidant and the like. Pigment particles, resin particles, or the like may also be contained for the purpose of prevention of image defects and the like.

<Photosensitive Layer>

The electrophotographic photoreceptor of the present invention includes a photosensitive layer. The electrophotographic photoreceptor of the present invention contains a charge generating material in the photosensitive layer in contact with the over coat layer.

The photosensitive layer may be a single layer photosensitive layer containing a charge generating material (CGM) and a hole transporting material (HTM) in one layer, or a laminate type photosensitive layer having a charge generating layer and a charge transporting layer separated from each other, and a single layer photosensitive layer is preferred since the effects of the present invention can be well enjoyed.

<Single Layer Photosensitive Layer>

The single layer photosensitive layer may be formed by using a binder resin for securing the strength thereof, in addition to the charge generating material and the charge transporting material. Specifically, the single layer photosensitive layer can be obtained in such a manner that the charge generating material, the charge transporting material, and various binder resins are dissolved or dispersed in a solvent to produce a coating liquid, which is coated on a conductive support (on the undercoating layer in the case where the undercoating layer is provided), and then dried. The negative charge generated by exposing the charge generating material is transported to the side of the photosensitive layer surface, and the positive charge is transported to the side of the conductive support, corresponding to the electric field formed in the photosensitive layer.

<Charge Generating Material>

Examples of the charge generating material include an inorganic photoconductive material, such as selenium and an alloy thereof and cadmium sulfide, and an organic photoconductive material, such as an organic pigment, in which an organic photoconductive material is preferred, and an organic pigment is particularly preferred. Examples of the organic pigment include a phthalocyanine pigment, an azo pigment, a dithioketopyrrolopyrrole pigment, a squalene (squalirium) pigment, a quinacridone pigment, an indigo pigment, a perylene pigment, a polycyclic quinone pigment, an anthanthrone pigment, and a benzimidazole pigment. Among these, a phthalocyanine pigment and an azo pigment are preferred. In the case where an organic pigment is used as the charge generating material, a dispersion layer containing fine particles of the organic pigment bound with various binder resins is generally used.

In the case where a phthalocyanine pigment is used as the charge generating material, specific examples thereof used include metal-free phthalocyanine, a phthalocyanine compound having various crystal forms having coordinated thereto a metal, such as copper, indium, gallium, tin, titanium, zinc, vanadium, silicon, germanium, and aluminum, and oxides, halides, hydroxides, alkoxides, and the like thereof, and a phthalocyanine dimer compound using an oxygen atom or the like as a crosslinking atom. In particular, X-type or τ-type metal-free phthalocyanine, A-type (also known as ß-type), B-type (also known as a-type), D-type (also known as Y-type), or the like titanyl phthalocyanine (also known as oxytitanium phthalocyanine), vanadyl phthalocyanine, chloro indium phthalocyanine, hydroxy indium phthalocyanine, II-type or the like chloro gallium phthalocyanine, V-type or the like hydroxy gallium phthalocyanine, G-type, I-type, or the like μ-oxogallium phthalocyanine dimer, and II-type or the like p-oxoaluminum phthalocyanine dimer are preferred.

Among these phthalocyanine compounds, X-type metal-free phthalocyanine, A-type (also known as B-type) or B-type (also known as a-type) titanyl phthalocyanine, D-type (Y-type) titanyl phthalocyanine having a clear peak at a diffraction angle 2θ±0.2° of 27.1° or 27.3° in powder X-ray diffraction, II-type chloro gallium phthalocyanine, V-type hydroxy gallium phthalocyanine, hydroxy gallium phthalocyanine having the strongest peak at 28.1°, or having no peak at 26.2° but having a clear peak at 28.1°, and having a half width W at 25.9° satisfying 0.1°≤W≤0.4° and G-type μ-oxogallium phthalocyanine dimer are particularly preferred.

A single compound of the phthalocyanine compound may be used, or a mixture or a mixed crystal of multiple kinds thereof may be used. The mixed state of the phthalocyanine compounds or the mixed state in the crystal state thereof may be a mixture obtained by mixing the constitutional elements later, or a mixed state obtained in the production or treatment process of the phthalocyanine compound, such as synthesis, pigment formation, and crystallization. Examples of the known treatment of this type include an acid pasting treatment, a grinding treatment, and a solvent treatment. Examples of the method of forming the mixed crystal state include a method in which two kinds of crystals are mixed, then mechanically grinding and forming into amorphous, and then converting to a particular crystal state through a solvent treatment, as described in JP H10-48859 A.

The particle diameter of the charge generating material is generally 1 μm or less, and preferably 0.5 μm or less. The amount of the charge generating material dispersed in the photosensitive layer is generally 0.1 part by mass or more, preferably 0.5 part by mass or more, and more preferably 1.0 part by mass or more, per 100 parts by mass of the binder resin. The amount thereof is generally 20 parts by mass or less, preferably 15 parts by mass or less, and more preferably 10 parts by mass or less, from the standpoint of the sensitivity.

<Binder Resin>

Examples of the binder resin include a vinyl polymer such as polymethyl methacrylate, polystyrene, and polyvinyl chloride, and a copolymer thereof; a thermoplastic resin, such as polycarbonate, polyarylate, polyester, polyester polycarbonate, polysulfone, phenoxy, epoxy and silicone resins, and various thermosetting resins. Among these resins, a polycarbonate resin and a polyarylate resin are preferred from the standpoint of the light attenuation characteristics and the mechanical strength of the photoreceptor.

Specific examples of the repeating unit preferred as the binder resin are shown below. These specific examples are shown for exemplification, and any known binder resin may be used by mixing unless the substance of the present invention is deviated.

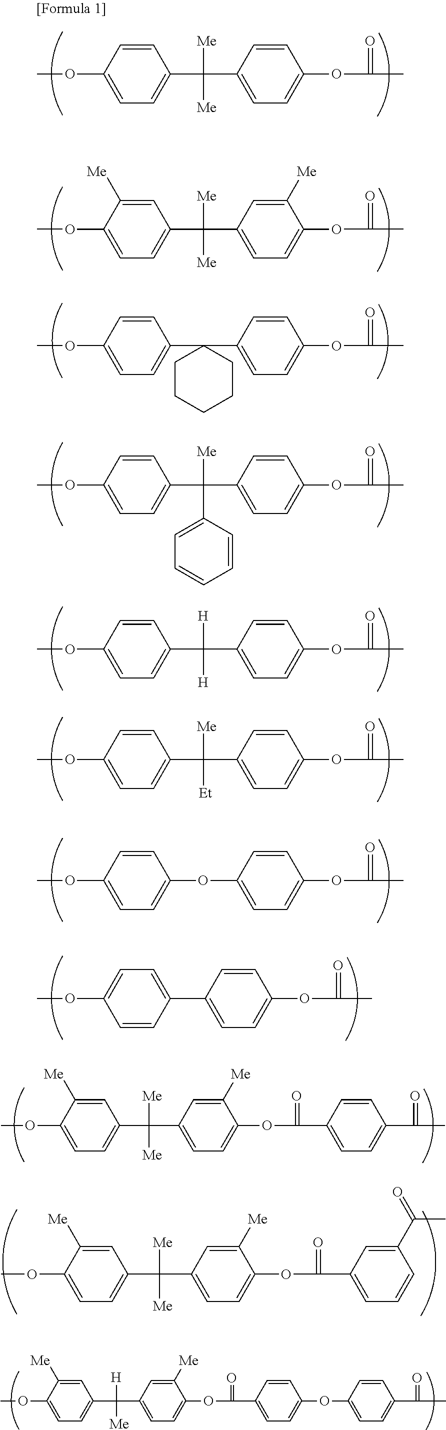

The viscosity average molecular weight of the binder resin is generally 20,000 or more, preferably 30,000 or more, more preferably 40,000 or more, and further preferably 50,000 or more, from the standpoint of the mechanical strength, and is generally 150,000 or less, preferably 120,000 or less, and more preferably 100,000 or less, from the standpoint of the production of the coating liquid for forming the photosensitive layer.

<Charge Transporting Material>

### [Electron Transporting Material]

The photosensitive layer preferably contains a compound represented by the following formula (1e) as the electron transporting material.

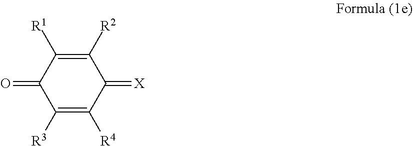

In the formula (1e), R¹ to R⁴ each independently represent a hydrogen atom, an alkyl group having 1 to 20 carbon atoms, which may have a substituent, or an alkenyl group having 2 to 20 carbon atoms, which may have a substituent, in which R¹ and R², or R³ and R⁴ may be bonded to each other to form a cyclic structure. X represents an organic residual group having a molecular weight of 120 or more and 250 or less.

R¹ to R⁴ each independently represent a hydrogen atom, an alkyl group having 1 to 20 carbon atoms, which may have a substituent, or an alkenyl group having 2 to 20 carbon atoms. Examples of the alkyl group having 1 to 20 carbon atoms, which may have a substituent, include a linear alkyl group, such as a methyl group, an ethyl group, and a hexyl group, a branched alkyl group, such as an isopropyl group, a tert-butyl group, and a tert-amyl group, and a cyclic alkyl group, such as a cyclohexyl group and a cyclopentyl group. Among these, an alkyl group having 1 to 15 carbon atoms is preferred from the standpoint of the versatility of the raw material, and an alkyl group having 1 to 10 carbon atoms is more preferred, and an alkyl group having 1 to 5 carbon atoms is further preferred, from the standpoint of the handleability in production. A linear alkyl group and a branched alkyl group are preferred from the standpoint of the electron transporting capability in which a methyl group, a tert-butyl group, and a tert-amyl group are more preferred, and a tert-butyl group and a tert-amyl group are further preferred from the standpoint of the solubility in an organic solvent used in a coating liquid.

Examples of the alkenyl group having 1 to 20 carbon atoms, which may have a substituent, include a linear alkenyl group, such as an ethenyl group, a branched alkenyl group, such as a 2-methyl-1-propenyl group, and a cyclic alkenyl group, such as a cyclohexenyl group. Among these, a linear alkenyl group having 2 to 10 carbon atoms is preferred from the standpoint of he light attenuation characteristics of the photoreceptor.

The substituents R¹ to R⁴, R¹ and R², or R³ and R⁴ may be bonded to each other to form a cyclic structure. In the case where both R¹ and R² represent alkenyl groups, it is preferred that both the groups are bonded to each other to form an aromatic ring, and it is more preferred that both R¹ and R² represent ethenyl groups, and both the groups are bonded to each other to form a benzene ring structure, from the standpoint of the electron mobility.

In the formula (1e), X represents an organic residual group having a molecular weight of 120 or more and 250 or less, and the compound represented by the formula (1e) is preferably a compound represented by any one of the following formulae (2e) to (5e) from the standpoint of the light attenuation characteristics of the photoreceptor:

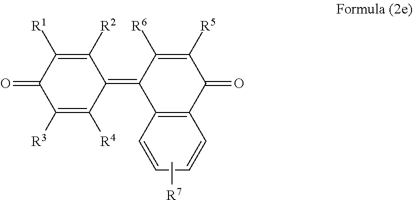

In the formula (2e), R⁵ to R⁷ each independently represent a hydrogen atom, or an alkyl group having 1 to 6 carbon atoms.

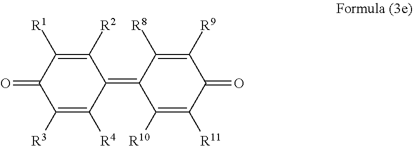

In the formula (3e), R⁸ to R¹¹ each independently represent a hydrogen atom, a halogen atom, or an alkyl group having 1 to 6 carbon atoms.

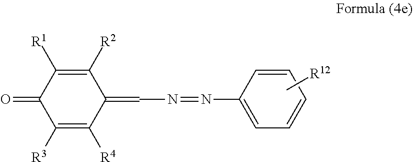

In the formula (4e), R¹² represents a hydrogen atom, an alkyl group having 1 to 6 carbon atoms, or a halogen atom.

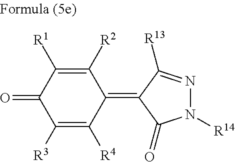

In the formula (5e), R¹³ and R¹⁴ each independently represent a hydrogen atom, an alkyl group having 1 to 6 carbon atoms, or an aryl group having 6 to 12 carbon atoms.

Examples of the alkyl group having 1 to 6 carbon atoms in R⁵ to R¹⁴ include a linear alkyl group, such as a methyl group, an ethyl group, and a hexyl group, a branched alkyl group, such as an isopropyl group, a tert-butyl group, and a tert-amyl group, and a cyclic alkyl group, such as a cyclohexyl group. A methyl group, a tert-butyl group, and a tert-amyl group are preferred from the standpoint of the electron transporting capability. Examples of the halogen atom include fluorine, chlorine, bromine, and iodine, in which chlorine is preferred from the standpoint of the electron transporting capability. Examples of the aryl group having 6 to 12 carbon atoms include a phenyl group and a naphthyl group, in which a phenyl group and a naphthyl group are preferred, and a phenyl group is more preferred, from the standpoint of the film properties of the photosensitive layer. Among the formulae (2e) to (5e), the compound represented by the formula (1e) is preferably a compound represented by the formula (2e) or the formula (3e), and more preferably a compound represented by the formula (3e), from the standpoint of the image stability in repeated image formation. The compound represented by the formula (1e) may be used alone, compounds represented by the formula (1e) having different structures may be used in combination, and another electron transporting material may also be used in combination. Examples of the structure of the electron transporting material are shown below.

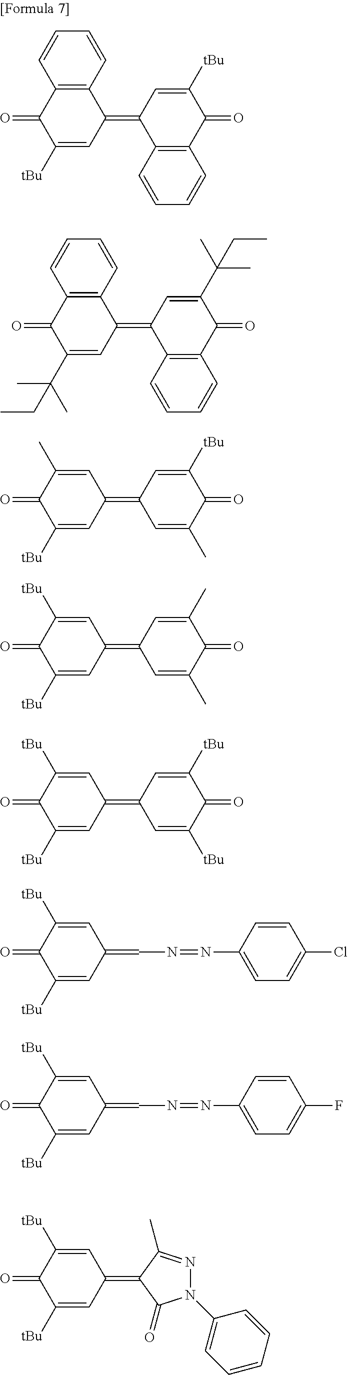

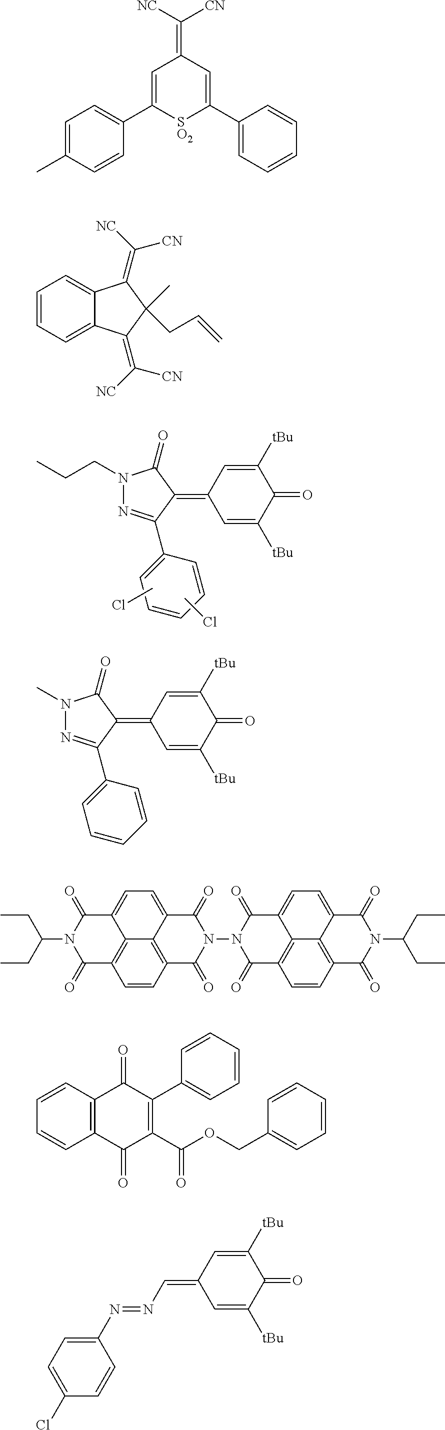

As another electron transporting material, a pigment having an electron transporting capability may be used in combination.

Examples of the pigment having an electron transporting capability include a known cyclic ketone compound, a known perylene pigment (perylene derivative), and a known azo pigment. Examples thereof are shown below.

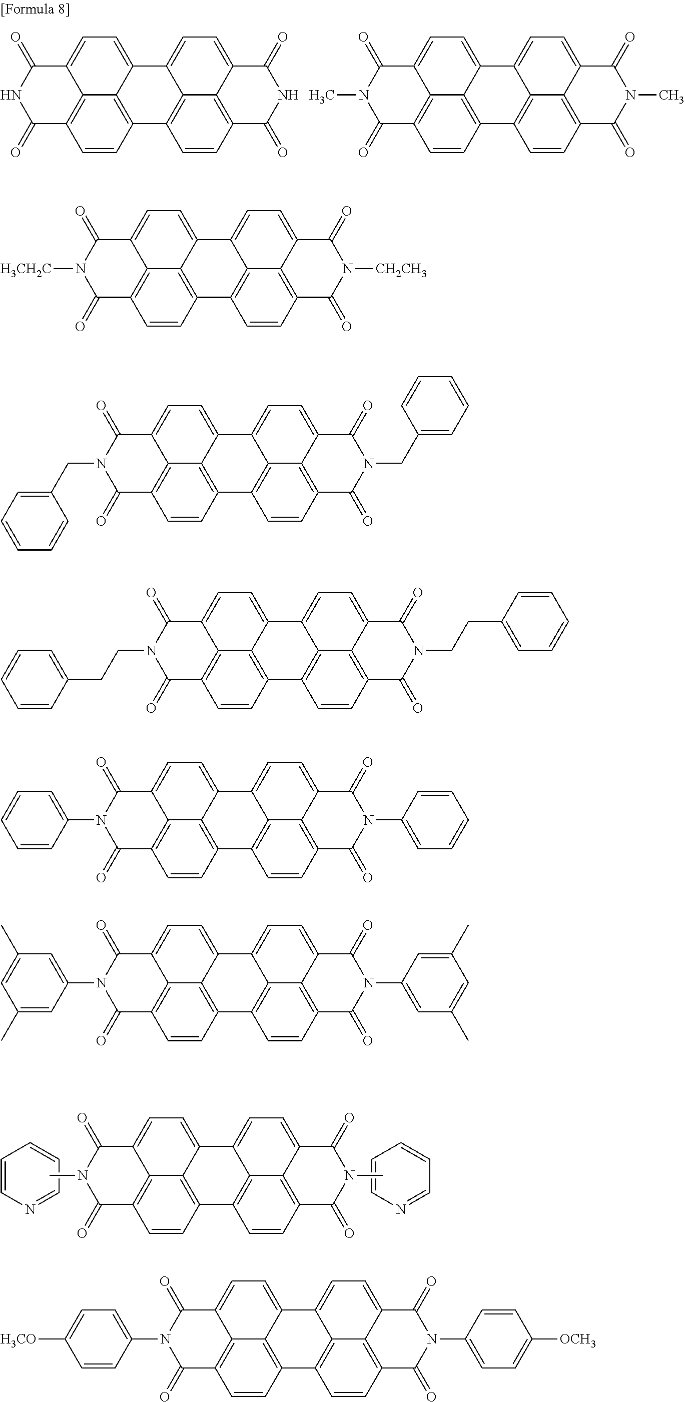

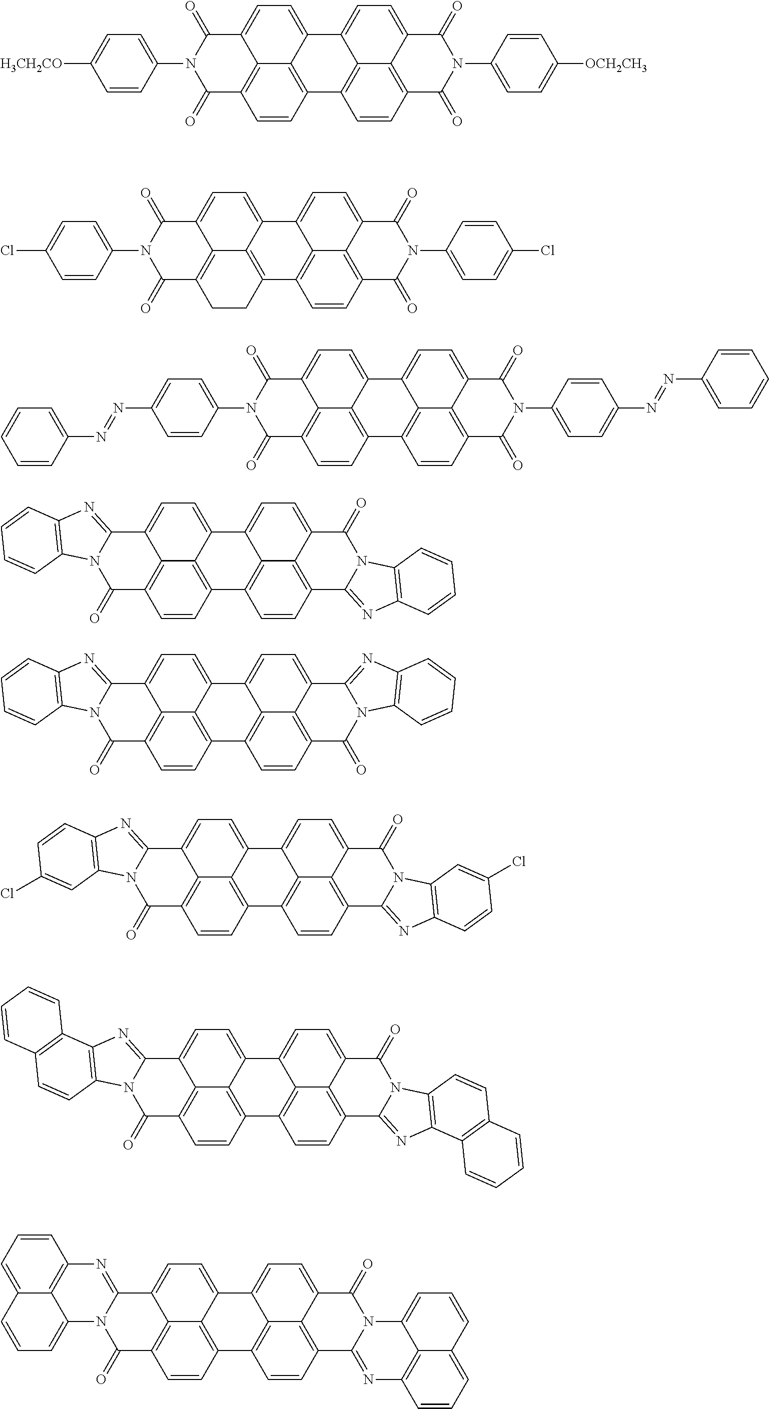

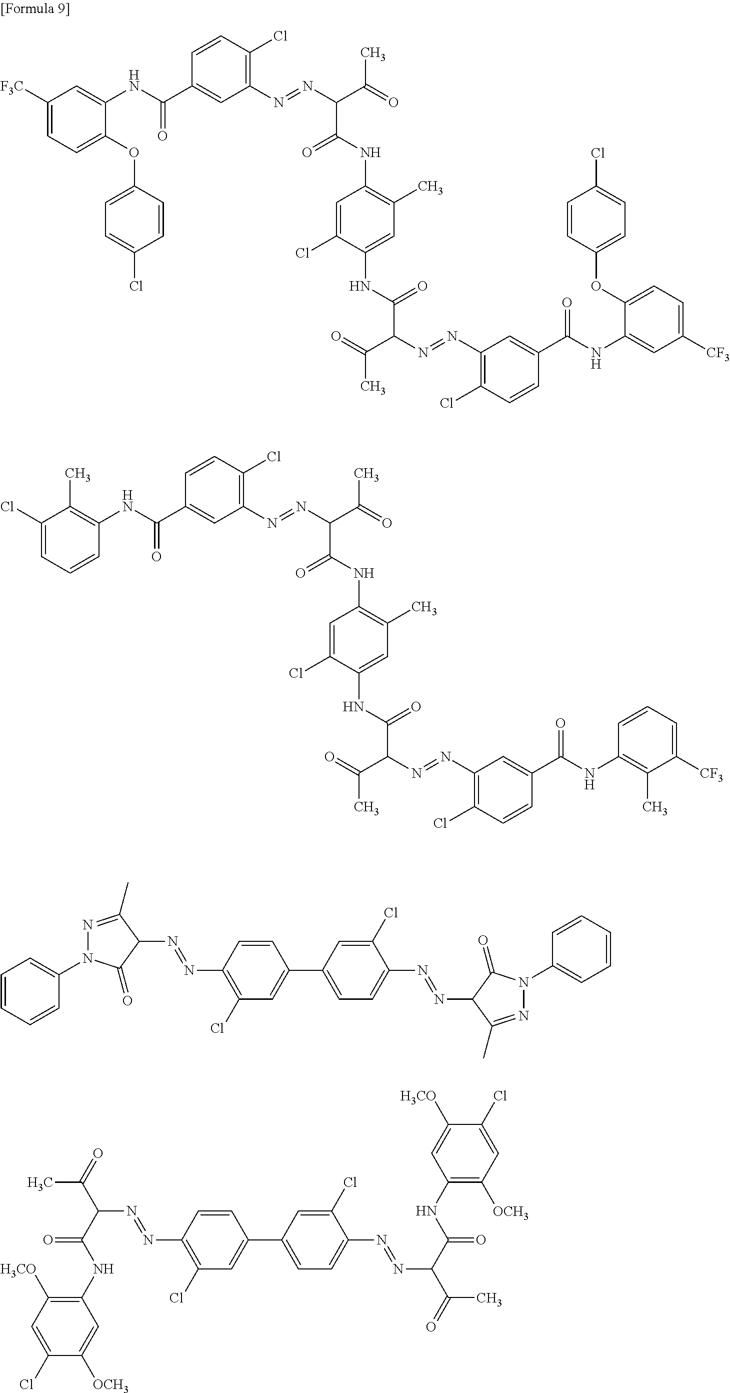

As for the ratio of the binder resin and the electron transporting material in the photosensitive layer, the amount of the electron transporting material is generally 10 parts by mass or more, preferably 30 parts by mass or more, more preferably 50 parts by mass or more, further preferably 60 parts by mass or more, and particularly preferably 100 parts by mass or more, per 100 parts by mass of the binder resin, from the standpoint of the electric characteristics. The amount of the electron transporting material is generally 300 parts by mass or less, preferably 200 parts by mass or less, and more preferably 150 parts by mass or less, from the standpoint of the compatibility with the binder resin.

<Hole Transporting Material>

The structure of the hole transporting material is not limited, and examples thereof include an electron donating substance, for example, an arylamine derivative, a stilbene derivative, a butadiene derivative, a hydrazone derivative, a carbazole derivative, an aniline derivative, an enamine derivative, and a combination of multiple kinds of these compounds bonded to each other, and a polymer having a group formed of any of these compounds the main chain or the side chain thereof. Among these, an arylamine derivative, a stilbene derivative, a hydrazone derivative, an enamine derivative, and a combination of multiple kinds of these compounds bonded to each other ae referred, in which an enamine derivative and a combination of multiple kinds of arylamine derivatives are more preferred, and an enamine derivative is further preferred. Multiple kinds of hole transporting materials may be used in combination.

As for the ratio of the binder resin and the hole transporting material in the photosensitive layer, the amount of the hole transporting material is preferably 50 parts by mass or more, more preferably 70 parts by mass or more, further preferably 80 parts by mass or more, and particularly preferably 100 parts by mass or more, and is preferably 300 parts by mass or less, more preferably 200 parts by mass or less, and particularly preferably 150 parts by mass or less, per 100 parts by mass of the binder resin.

[Formula 10]

The structure of preferred hole transport materials is exemplified below.

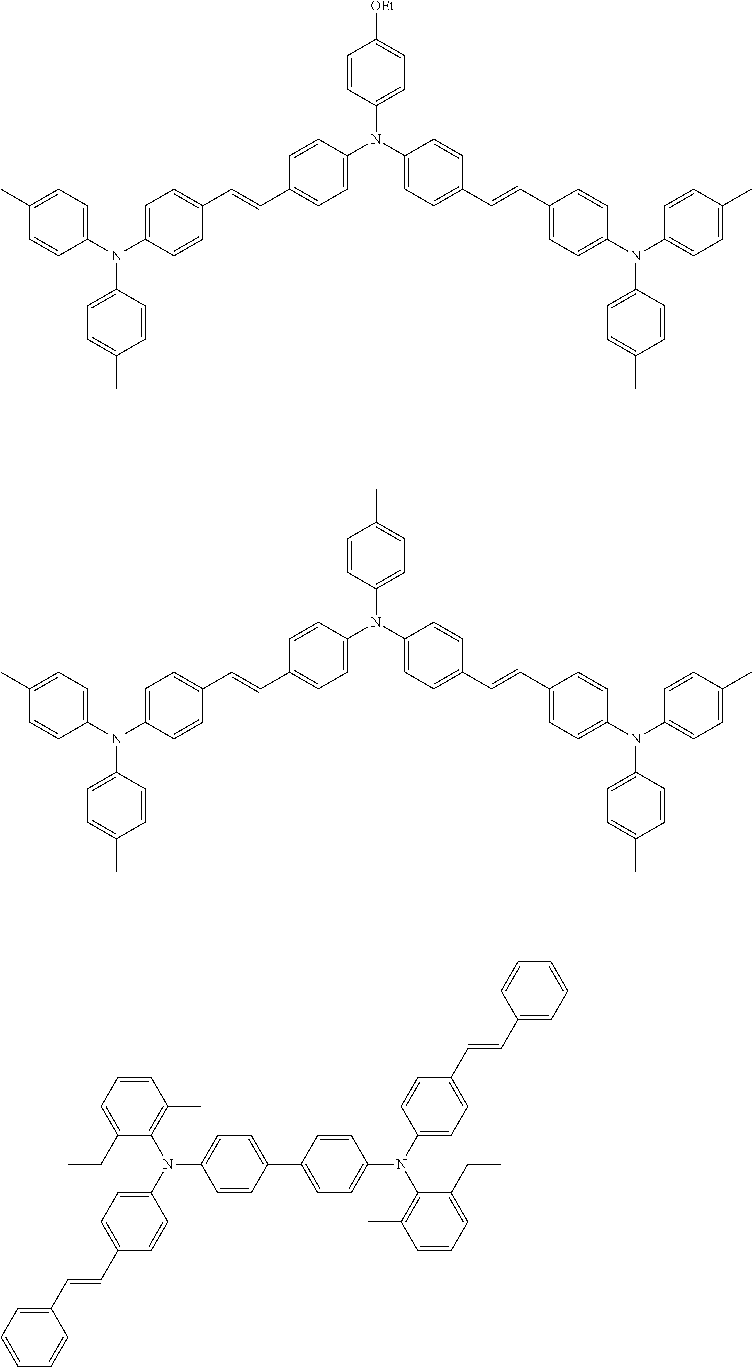

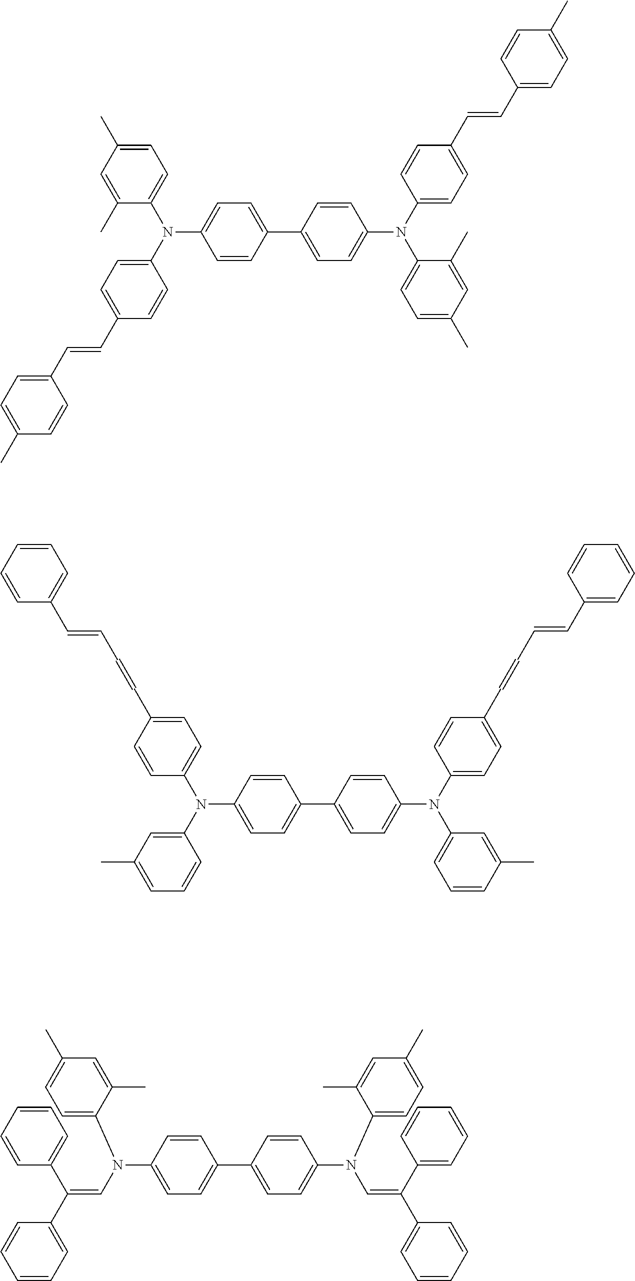 [SMILES: Cc1ccc(/C=C/c2ccc(N(c3ccc(-c4ccc(N(c5ccc(/C=C/c6ccc(C)cc6)cc5)c5ccc(C)cc5C)cc4)cc3)c3ccc(C)cc3C)cc2)cc1 ; Cc1cccc(N(c2ccc(C=C/C=C/c3ccccc3)cc2)c2ccc(-c3ccc(N(c4ccc(C=C/C=C/c5ccccc5)cc4)c4cccc(C)c4)cc3)cc2)c1 ; Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1]

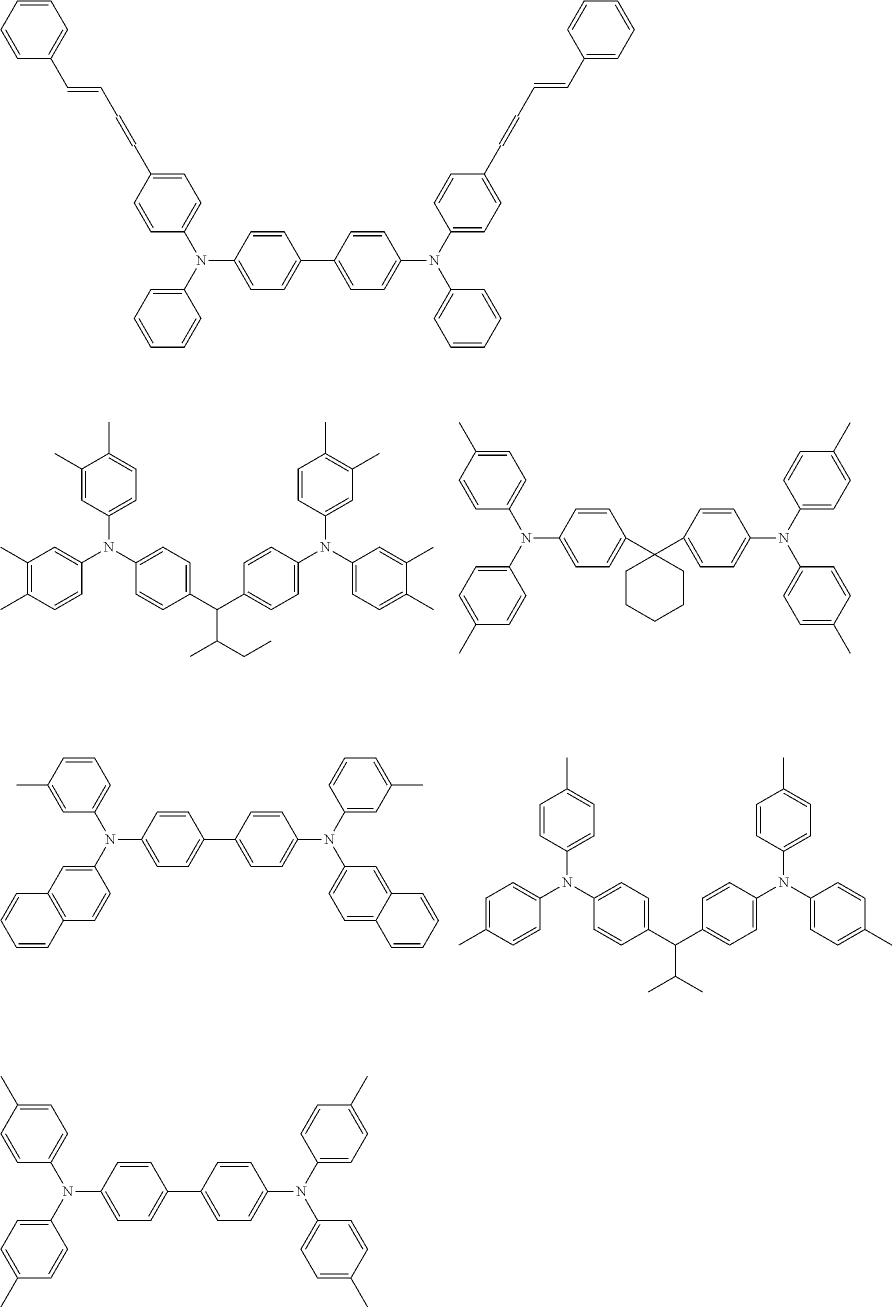

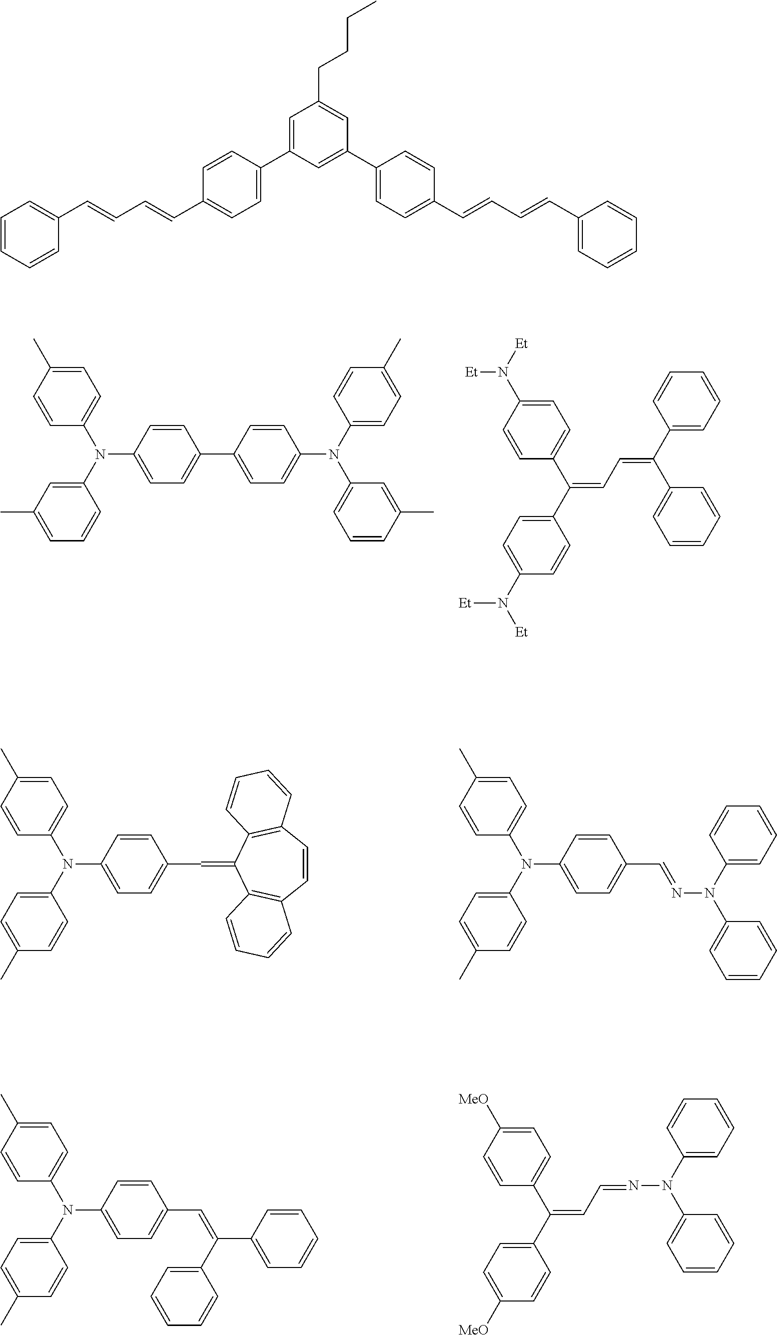

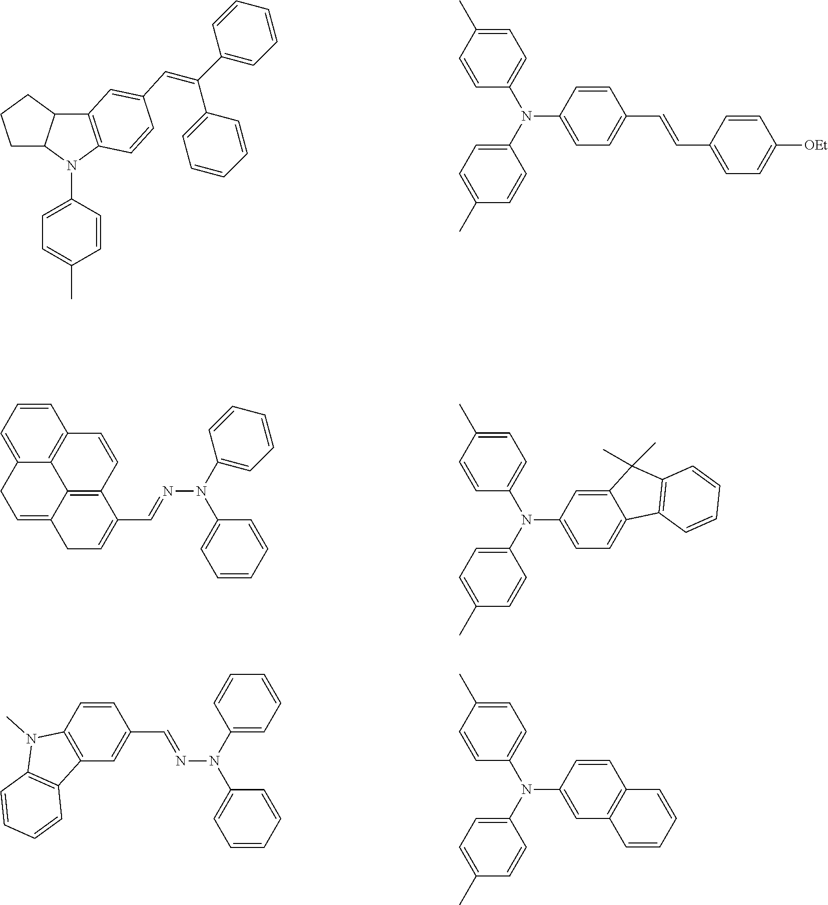

<Other Additives>

The photosensitive layer may contain known additives, such as an antioxidant, a plasticizer, an ultraviolet ray absorbent, an electron withdrawing compound, a leveling agent, a visible light shielding agent, and a space filler, for enhancing the film formability, the flexibility, the coatability, the contamination resistance, the gas resistance, the light resistance, and the like.

Examples of the additive contained include tribenzylamine as an antioxidant. As for the ratio of the binder resin and the additive in the photosensitive layer, the amount of the additive may be 0.1 part by mass or more, preferably 1 part by mass or more, and more preferably 5 parts by mass or more, per 100 parts by mass or the binder resin. The upper limit thereof may be 100 parts by mass or less, preferably 50 parts by mass or less, and more preferably 30 parts by mass or less.

<Laminate type Photosensitive Layer>

The laminate type photosensitive layer is preferably a reversed laminate type photosensitive layer including a charge transporting layer and a charge generating layer laminated in this order, and even a normal laminate type photosensitive layer including the charge generating layer and the charge transporting layer laminated in this order can enjoy the effects of the present invention in the case where the photosensitive layer in contact with the over coat layer, i.e., the charge transporting layer, contains a charge generating material.

Examples of the charge generating material, the hole transporting material, the electron transporting material, the binder resin, and other additives that can be contained in the laminate type photosensitive layer include the same ones as the compounds that can be contained in the single layer photosensitive layer described above. The contents thereof in the laminate type photosensitive layer are not particularly limited, and may be optional amounts.

< Over Coat Layer (OCL)>

The over coat layer of the photoreceptor of the present invention will be described. In the following description, the over coat layer may be abbreviated as OCL.

In the present invention, the over coat layer contains a cured product formed by curing a curable compound, such as a photocurable compound, and thereby the problems, such as the adverse effect of ozone in the printing cycle, the deterioration of the chargeability, and the occurrence of leak, can be solved. The curable compound herein means a compound that forms a crosslinked structure with light, heat, or the like.

In the case where the over coat layer contains a cured product formed by curing a curable compound, the curable compound forms a dense three-dimensional network structure, and thereby ozone gas can be prevented from invading the single layer photosensitive layer.

In the layer of the curable compound, such as a photo-cured polymer, having been crosslinked to form a dense three-dimensional network structure, the hole transporting material and the electron transporting material existing in the photosensitive layer can be prevented from invading the over coat layer due to the difficulty in molecular migration in the layer, and the so-called bleed-out of the hole transporting material and the electron transporting material to the photoreceptor surface, which is a factor of the deterioration of the chargeability, can be suppressed from occurring. An additive has been added as the countermeasure for the bleed-out of the hole transporting material and the electron transporting material from the single layer photosensitive layer, but in this case, the amount of bleed-out can be reduced, but the occurrence of the bleed-out itself cannot be suppressed. In the present invention, a fundamental countermeasure can be achieved without the addition of an additive, which is advantageous also from the standpoint that the amounts of the functional materials in the photosensitive layer can be relatively increased.

Furthermore, in the case where the over coat layer contains a cured product formed by curing a curable compound, such as a photocurable compound, the aggregate of the charge generating material, which may be a start point of leak, is hidden by the over coat layer, so as to prevent the electric field from being concentrated to the aggregate, and thus the leak can be suppressed from occurring.

As a result of the investigations by the present inventors, it has been found that the suppression of invasion of water molecules to the over coat layer is effective for suppressing the occurrence of leak. The cured product formed by curing the curable compound contained in the over coat layer of the present invention has a densely crosslinked three-dimensional network structure, and thereby it is possible to suppress water from invading. On the other hand, for example, an over coat layer using a thermoplastic resin, such as a polyamide, can prevent the electric field from being concentrated to the aggregate of the charge generating material, but due to the water absorbability thereof, the suppression of the invasion of water cannot be expected thereby. Even a hydrophobic thermoplastic resin is considered to fail to prevent the invasion of water completely since the resin does not have a densely crosslinked three-dimensional network structure.

In addition, the mechanical strength of the over coat layer can be enhanced by curing the curable compound, and thereby the abrasion resistance can also be achieved.

The materials used in the over coat layer (i.e., the curable compound, the charge transporting material, the metal oxide particles, and the polymerization initiator) will be described in detail below.

(Curable Compound)

The over coat layer of the present invention contains the curable compound having been cured. Examples of the curable compound include a compound having a chain polymerizable functional group, such as a photocurable compound.

The compound having a chain polymerizable functional group used in the over coat layer generally has 2 or more, preferably 3 or more, and more preferably 4 or more, and on the other hand, generally 20 or less, preferably 10 or less, and more preferably 6 or less chain polymerizable functional groups from the standpoint of the reactivity.

Examples of the chain polymerizable functional group of the compound having a chain polymerizable functional group used in the over coat layer include an acryloyl group, a methacryloyl group, a vinyl group, and an epoxy group. Any known material may be used with no particular limitation as the compound having a chain polymerizable functional group, and a monomer, an oligomer, and a polymer having an acryloyl group or a methacryloyl group are preferred from the standpoint of the curability.

Examples of the preferred compound will be described. Examples of the monomer having an acryloyl group or a methacryloyl group include trimethylolpropane triacrylate (TMPTA), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate, glycerol triacrylate, ECH-modified glycerol triacrylate, EO-modified glycerol triacrylate, PO-modified glycerol triacrylate, tris(acryloxyethyl) isocyanurate, caprolactone-modified tris(acryloxyethyl) isocyanurate, EO-modified tris(acryloxyethyl) isocyanurate, PO-modified tris(acryloxyethyl) isocyanurate, dipentaerythritol hexaacrylate, caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate, pentaerythritol ethoxytetraacrylate, EO-modified phosphate triacrylate, 2,2,5,5-tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecanedimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecanedimethanol dimethacrylate, decanediol dimethacrylate, and hexanediol dimethacrylate.

Examples of the oligomer and the polymer having an acryloyl group or a methacryloyl group used include a urethane acrylate, an ester acrylate, an acrylic acrylate, and an epoxy acrylate, known in the art. Examples of the urethane acrylate include “EBECRYL8301”, “EBECRYL1290”, “EBECRYL1830”, and “KRM8200” (available from Daicel-Allnex, Ltd.), and “UV1700B”, “UV7640B”, “UV7605B”, “UV6300B”, and “UV7550B” (available from Mitsubishi Chemical Corporation). Examples of the ester acrylate include “M-7100”, “M-7300K”, “M-8030”, “M-8060”, “M-8100”, “M-8530”, “M-8560”, and “M-9050” (available from Toagosei Co., Ltd.). Examples of the acrylic acrylate include “8BR-600”, “8BR-930 MB”, “8KX-078”, “8KX-089”, and “8KX-168” (available from Taisei Fine Chemical Co., Ltd.).

These compounds may be used alone or as a combination of two or more kinds thereof.

The over coat layer of the present invention may contain metal oxide particles and a charge transporting material for the purpose of imparting a charge transporting capability in addition to the compound having a chain polymerizable functional group. A polymerization initiator may be used for accelerating the polymerization reaction in curing the over coat layer.

(Charge Transporting Material Used in Over Coat Layer)

The charge transporting material contained in the over coat layer may be the same as the charge transporting material used in the photosensitive layer. In addition, a polymer having a partial structure having a charge transporting capability may be used from the standpoint of enhancing the mechanical strength of the over coat layer. Examples of the chain polymerizable functional group of the charge transporting material having a chain polymerizable functional group include an acryloyl group, a methacryloyl group, a vinyl group, and an epoxy group. Among these, an acryloyl group and a methacryloyl group are preferred from the standpoint of the curability. Examples of the structure of the charge transporting material moiety of the charge transporting material having a chain polymerizable functional group include an electron donating substance, for example, a heterocyclic compound, such as a carbazole derivative, an indole derivative, an imidazole derivative, an oxazole derivative, a pyrazole derivative, a thiadiazole derivative, and an benzofuran derivative, an aniline derivative, a hydrazone derivative, an aromatic amine derivative, an arylamine derivative, a stilbene derivative, a butadiene derivative, and an enamine derivative, and a combination of multiple kinds of these compounds bonded to each other, and a polymer having a group formed of any of these compounds on the main chain or the side chain thereof. Among these, a carbazole derivative, an aromatic amine derivative, an arylamine derivative, a stilbene derivative, a butadiene derivative, and an enamine derivative, and a combination of multiple kinds of these compounds bonded to each other are preferred from the standpoint of the electric characteristics.

The partial structure having a charge transporting capability is preferably a structure represented by the following formula (3).

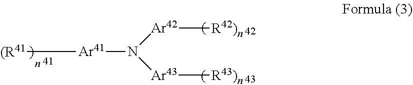

In the formula (3), Ar⁴¹ to Ar⁴³ each represent an aromatic group; R⁴¹ to R⁴³ each independently represent a hydrogen atom, an alkyl group, an alkoxy group, an aryl group, a halogenated alkyl group, a halogen group, a benzyl group, or the following formula (4); and n⁴¹ to n⁴³ each represent an integer of 1 or more, provided that in the case where n⁴¹ is 1, R⁴¹ is the formula (4); in the case where n⁴¹ is an integer of 2 or more, R⁴¹ may be the same as or different from each other, at least one of which is the formula (4); in the case where n⁴² is an integer of 2 or more, R⁴² may be the same as or different from each other; and in the case where n⁴³ is an integer of 2 or more, R⁴³ may be the same as or different from each other.

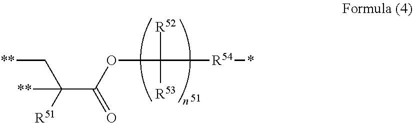

In the formula (4), R⁵¹ represents a hydrogen atom or a methyl group; R⁵² and R⁵³ each independently represent a hydrogen atom, a hydrocarbon group, or an alkoxy group; R⁵⁴ represents a single bond or an oxygen atom; n⁵¹ represents an integer of 0 or more and 10 or less; *represents a bonding site to Ar⁴¹ to Ar⁴³; and ** represents a bonding site to an arbitrary atom.

In the formula (3), Ar⁴¹ to Ar⁴³ each represent an aromatic group, and examples of the monovalent aromatic group include a phenyl group, a naphthyl group, an anthracenyl group, a phenanthrenyl group, a pyrenyl group, a biphenylyl group, and a fluorenyl group. Among these, a phenyl group is preferred from the standpoint of the solubility and the photocurability. Examples of the divalent aromatic group include a phenylene group, a naphthylene group, an anthrylene group, a phenanthrenediyl group, a pyrenylene group, and a biphenyldiyl group. Among these, a phenylene group is preferred from the standpoint of the solubility and the photocurability.

R⁴¹ to R⁴³ each independently represent a hydrogen atom, an alkyl group, an alkoxy group, an aryl group, a halogenated alkyl group, a halogen group, a benzyl group, or the formula (4). Among these, the number of carbon atoms of the alkyl group, the alkoxy group, the aryl group, and the halogenated alkyl group is generally 1 or more and 10 or less, preferably 8 or less, more preferably 6 or less, and further preferably 4 or less. Specific examples of the alkyl group include a methyl group, an ethyl group, a propyl group, an isopropyl group, a butyl group, a tert-butyl group, an isobutyl group, and a cyclohexyl group. Specific examples of the alkoxy group include a methoxy group, an ethoxy group, a propoxy group, and a cyclohexyloxy group. Examples of the aryl group include a phenyl group and a naphthyl group. Examples of the halogenated alkyl group include a chloroalkyl group and a fluoroalkyl group. Examples of the halogen group include a fluoro group, a chloro group, and a bromo group. A methyl group, an ethyl group, and a phenyl group are more preferred.

n⁴¹ to n⁴³ each represent an integer of 1 or more, generally 1 or more and 5 or less, preferably 3 or less, and most preferably 1, provided that in the case where n⁴¹ is 1, R⁴¹ is the formula (4); in the case where n⁴¹ is an integer of 2 or more, R⁴¹ may be the same as or different from each other, at least one of which is the formula (4); in the case where n⁴² is an integer of 2 or more, R⁴² may be the same as or different from each other; and in the case where n⁴³ is an integer of 2 or more, R⁴³ may be the same as or different from each other. The case where n⁴¹ to n⁴³ are 1, R⁴¹ is the formula (4), and any one of R⁴² and R⁴³ is the formula (4), and the case where n⁴¹ to n⁴³ are 1, R⁴¹ to R⁴³ are the formula (4) are preferred from the standpoint of the strength of the cured film, and the case where n⁴¹ to n⁴³ are 1, R⁴¹ is the formula (4), and any one of R⁴² and R⁴³ is the formula (4) is more preferred from the standpoint of the solubility. Examples of R⁵² and R⁵³ include the equivalent ones to R²² and R²³.

n⁵¹ represents an integer of 0 or more and 10 or less, generally 0 or more and 10 or less, preferably 6 or less, more preferably 4 or less, and further preferably 3 or less.

The raw material of the polymer having a structure represented by the formula (3) is not particularly limited, and the polymer is preferably obtained through polymerization of a compound having a structure represented by the following formula (3′).

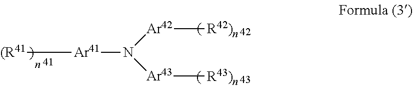

In the formula (3′), Ar⁴¹ to Ar⁴³ each represent an aromatic group; R⁴¹ to R⁴³ each independently represent a hydrogen atom, an alkyl group, an alkoxy group, an aryl group, a halogenated alkyl group, a halogen group, a benzyl group, or the following formula (4′); and n⁴¹ to n⁴³ each represent an integer of 1 or more, provided that in the case where n⁴¹ is 1, R⁴¹ is the formula (4′); in the case where n⁴¹ is an integer of 2 or more, R⁴¹ may be the same as or different from each other, at least one of which is the formula (4′); in the case where n⁴² is an integer of 2 or more, R⁴² may be the same as or different from each other; and in the case where n⁴³ is an integer of 2 or more, R⁴³ may be the same as or different from each other.

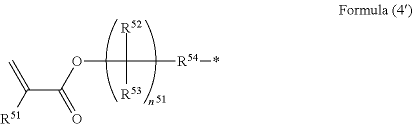

In the formula (4′), R⁵¹ represents a hydrogen atom or a methyl group; R⁵² and R⁵³ each independently represent a hydrogen atom, a hydrocarbon group, or an alkoxy group; R⁵⁴ represents a single bond or an oxygen atom; n⁵¹ represents an integer of 0 or more and 10 or less; and * represents a bonding site to Ar⁴¹ to Ar⁴³. Specific examples of the structure represented by the formula (3′) are shown below.

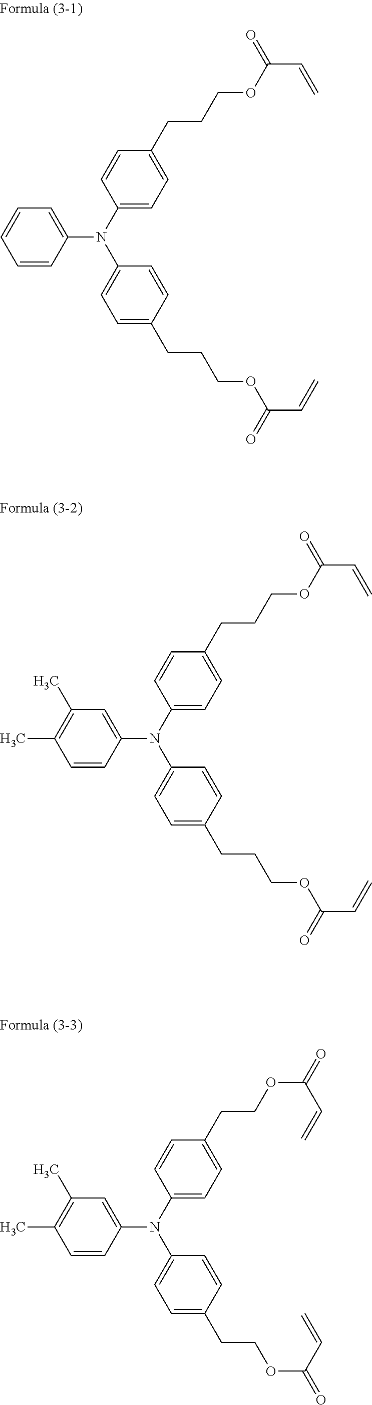

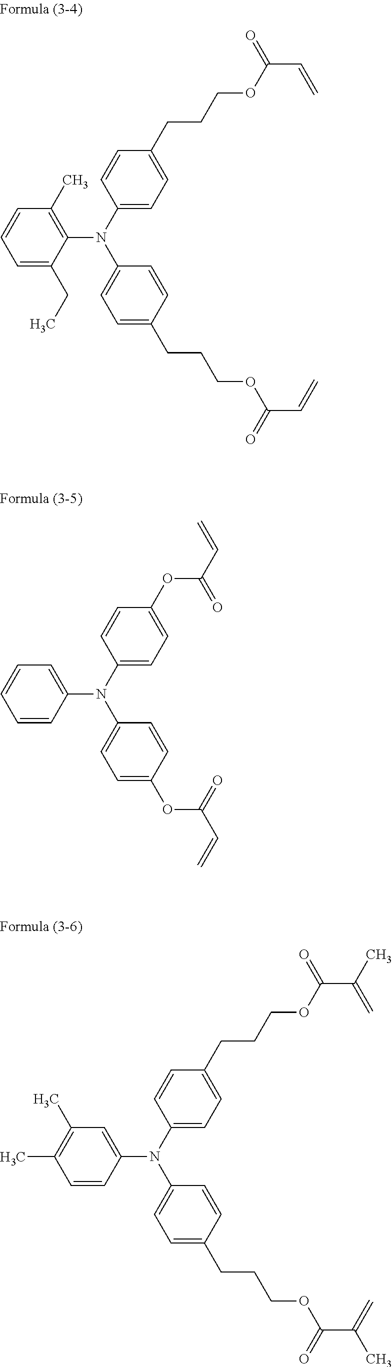

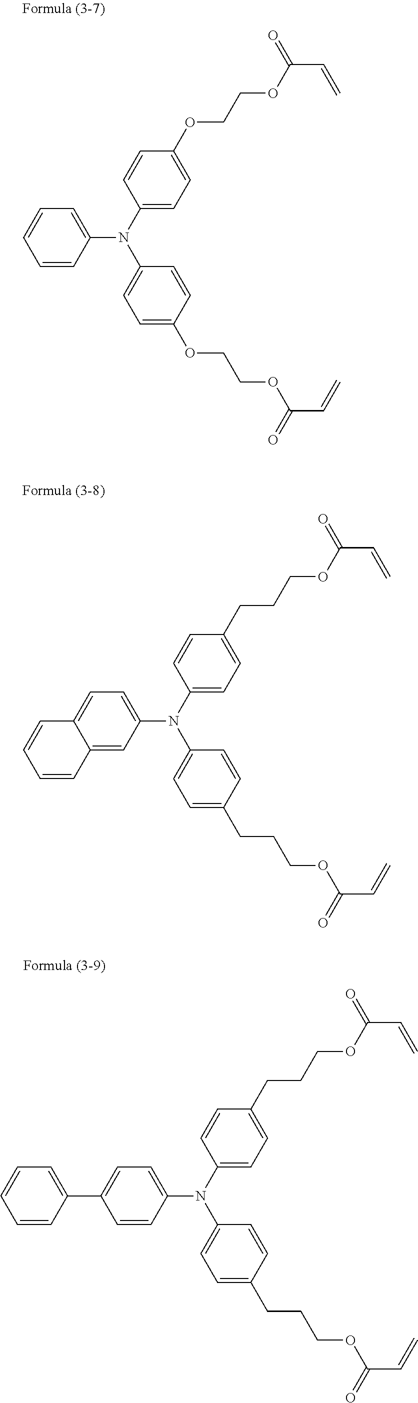 [SMILES: C=CC(=O)OCCOc1ccc(N(c2ccccc2)c2ccc(OCCOC(=O)C=C)cc2)cc1 ; C=CC(=O)OCCCc1ccc(N(c2ccc(CCCOC(=O)C=C)cc2)c2ccc3ccccc3c2)cc1 ; C=CC(=O)OCCCc1ccc(N(c2ccc(CCCOC(=O)C=C)cc2)c2ccc(-c3ccccc3)cc2)cc1]

Among the compounds, the formula (3-1), the formula (3-2), the formula (3-3), the formula (3-4), the formula (3-6), and the formula (3-7) are preferred, and the formula (3-1), the formula (3-2), and the formula (3-3) are more preferred from the standpoint of the electric characteristics.

The amount of the charge transporting material used in the over coat layer of the electrophotographic photoreceptor according to the present invention is not particularly limited, and the charge transporting material is preferably used in an amount in a range of 10 to 300 parts by mass per 100 parts by mass of the binder resin. The amount thereof is more preferably 30 to 200 parts by mass, and particularly preferably 50 to 150 parts by mass. In the case where the content of the charge transporting material is smaller than the range, the charge transporting capability may be insufficient, and the electric characteristics may be deteriorated. In the case where the content of the charge transporting material is larger than the range, the surface resistance of the outermost surface may be lowered to cause image defects, such as image deletion.

(Metal Oxide Particles)

The over coat layer of the present invention may contain metal oxide particles from the standpoint of imparting a charge transporting capability and the standpoint of enhancing the mechanical strength.

The metal oxide particles used may be any type of metal oxide particles that are generally applicable to electrophotographic photoreceptors. More specific examples of the metal oxide particles include metal oxide particles containing one kind of a metal element, such as titanium oxide, tin oxide, aluminum oxide, silicon oxide, zirconium oxide, zinc oxide, and iron oxide, and metal oxide particles containing multiple kinds of metal elements, such as calcium titanate, strontium titanate, and barium titanate. Among these, metal oxide particles that have a band gap of 2 to 4 eV are preferred. One kind of the metal oxide particles may be used alone, or multiple kinds of particles may be used by mixing. Among the metal oxide particles, titanium oxide, tin oxide, aluminum oxide, silicon oxide, and zinc oxide are preferred, titanium oxide and tin oxide are more preferred, and titanium oxide is particularly preferred.

The crystal form of titanium oxide particles used may be any of rutile, anatase, brookite, and amorphous. Multiple kinds of crystal states from these crystal states may be contained.

The metal oxide particles may have a surface having been subjected to various surface treatments. For example, the surface thereof may be subjected to a treatment with an inorganic material, such as tin oxide, aluminum oxide, antimony oxide, zirconium oxide, and silicon oxide, or an organic material, such as stearic acid, a polyol, and an organic silicon compound. In the case where titanium oxide particles are used, in particular, the surface thereof is preferably treated with an organic silicon compound. Examples of the organic silicon compound include a silicone oil, such as dimethylpolysiloxane and methyl hydrogen polysiloxane, an organosilane, such as methyldimethoxysilane and diphenyldimethoxysilane, a silazane, such as hexamethyldisilazane, and a silane coupling agent, such as 3-methacryloyloxypropyltrimethoxysilane, 3-acryloyloxypropyltrimethoxysilane, vinyltrimethoxysilane, y-mercaptopropyltrimethoxysilane, and y-aminopropyltriethoxysilane. In particular, 3-methacryloyloxypropyltrimethoxysilane, 3-acryloyloxypropyltrimethoxysilane, vinyltrimethoxysilane, which have a chain polymerizable functional group, are preferred from the standpoint of enhancing the mechanical strength of the over coat layer.

The outermost surface of the surface-treated particles has been treated with the aforementioned treating agent, and may be treated, before the treatment, with a treating agent, such as aluminum oxide, silicon oxide, and zirconium oxide. One kind of the metal oxide particles may be used alone, or multiple kinds of the particles may be used by mixing.

The metal oxide particles used generally have an average primary particle diameter of preferably 500 nm or less, more preferably 1 to 100 nm, and further preferably 5 to 50 nm. The average primary particle diameter can be obtained from the arithmetic average value of the diameters of the particles that are directly observed with a transmission electron microscope (which may be hereinafter referred to as TEM).

As the metal oxide particles in the present invention, specific examples of the trade name of titanium oxide particles include titanium oxide ultrafine particles subjected to no surface treatment “TTO-55(N)” and “TTO-51(N)”, titanium oxide ultrafine particles coated with Al₂O₃“TTO-55(A)” and “TTO-55(B)”, titanium oxide ultrafine particles subjected to surface treatment with stearic acid “TTO-55(C)”, titanium oxide ultrafine particles subjected to surface treatment with Al₂O₃ and organosiloxane “TTO55(S)”, high purity titanium oxide “C-EL”, sulfuric acid method titanium oxide “R-550”, “R-580”, “R-630”, “R-670”, “R-680”, “R-780”, “A-100”, “A-220”, and “W-10”, chlorine method titanium oxide “CR-50”, “CR-58” “CR-60”, “CR-60-2”, and “CR-67” and conductive titanium oxide “ET-300W” (all available from Ishihara Sangyo Kaisha, Ltd.), titanium oxide “R-60”, “A-110”, and “A-150”, Al₂O₃-coated titanium oxide “SR-1”, “RGL”, “R-5N”, “R-5N-2” “R-52N”, “RK-1”, and “A-SP”, SiO₂ and Al₂O₃-coated titanium oxide “R-GX” and “R-7E”, ZnO, SiO₂, and Al₂O₃-coated titanium oxide “R-650”, and ZrO₂ and Al₂O₃-coated titanium oxide “R-61N” (all available from Sakai Chemical Industry Co., Ltd.), titanium oxide subjected to surface treatment with SiO₂ and Al₂O₃“TR-700”, titanium oxide subjected to surface treatment with ZnO, SiO₂, and Al₂O₃“TR-840” and “TA-500”, titanium oxide subjected to no surface treatment “TA-100”, “TA-200”, and “TA-300”, and titanium oxide subjected to surface treatment with Al₂O₃“TA-400” (all available from Fuji Titanium Industry Co., Ltd.), and titanium oxide subjected to no surface treatment “MT-150W” and “MT-500B”, titanium oxide subjected to surface treatment with SiO₂ and Al₂O₃ “MT-100SA” and “MT-500SA”, and titanium oxide subjected to surface treatment with SiO₂, Al₂O₃, and organosiloxane “MT-100SAS” and “MT-500SAS” (all available from Tayca Co., Ltd.). Specific examples of the trade name of aluminum oxide particles include “Aluminium Oxide C” (available from Nippon Aerosil Co., Ltd.). Specific examples of the trade name of silicon oxide particles include “200CF” and “R⁹⁷²” (available from Nippon Aerosil Co., Ltd.) and “KEP-30” (available from Nippon Shokubai Co., Ltd.).

Specific examples of the trade name of tin oxide particles include “SN-100P” and “SN-100D” (all available from Ishihara Sangyo Kaisha, Ltd.), “SnO2” (available from CIK NanoTek Corporation), and “S-2000”, phosphorus-doped tin oxide “SP-2”, antimony-doped tin oxide “T-1”, and indium-doped tin oxide “E-ITO” (all available from Mitsubishi Materials Corporation).

Specific examples of the trade name of zinc oxide particles include “MZ-305S” (available from Tayca Co., Ltd.). The metal oxide particles capable of being used in the present invention are not limited to these materials.

The content of the metal oxide particles in the over coat layer of the electrophotographic photoreceptor according to the present invention is not particularly limited, is preferably 10 parts by mass or more, more preferably 20 parts by mass or more, and particularly preferably 30 parts by mass or more, from the standpoint of the electric characteristics, and is preferably 300 parts by mass or less, more preferably 200 parts by mass or less, and particularly preferably 100 parts by mass or less, from the standpoint of retaining a good surface resistance, all per 100 parts by mass of the binder resin.

The content ratio (mass ratio) of the metal oxide particles with respect to the curable compound in the over coat layer of the electrophotographic photoreceptor of the present invention is not particularly limited, is preferably 0.1 or more, more preferably 0.5 or more, further preferably 0.8 or more, and particularly preferably 1.5 or more, and is preferably 10 or less, more preferably 5 or less, and particularly preferably 3 or less.

(Polymerization Initiator)

The polymerization initiator includes a photopolymerization initiator.

The photopolymerization initiator is classified into a direct cleavage type and a hydrogen abstraction type depending on the difference in radical generation mechanism. The photopolymerization initiator of the direct cleavage type receives light energy and a part of the covalent bonds in the molecule is cleaved to generate radicals. The photopolymerization initiator of the hydrogen abstraction type receives light energy and the molecule becoming an excitation state abstracts hydrogen from the hydrogen donor to generate radicals.

Examples of the photopolymerization initiator of the direct cleavage type include an acetophenone based or ketal based compound, such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone, a benzoin ether based compound, such as benzoin, benzoin methyl ether, benzoin ethyl ether, benzoin isobutyl ether, benzoin isopropyl ether, and O-tosylbenzoin, and an acylphosphine oxide based compound, such as diphenyl(2,4,6-trimethylbenzoyl)phosphine oxide, phenylbis(2,4,6-trimethylbenzoyl)phosphine oxide, and lithium phenyl(2,4,6-trimethylbenzoyl)phosphonate.

Examples of the photopolymerization initiator of the hydrogen abstraction type include a benzophenone based compound, such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene, and an anthraquinone based or thioxanthone based compound, such as 2-ethylanthraquinone, 2-isopropylthioxanthone, 2-chlorothioxanthone, 2,4-dimethylthioxanthone, 2,4-diethylthioxanthone, and 2,4-dichlorothioxanthone. Examples of other photopolymerization initiators include camphorquinone, 1-phenyl-1,2-propanedione-2-(o-ethoxycarbonyl)oxime, an acridine based compound, a triazine based compound, and an imidazole based compound.

The photopolymerization initiator preferably has an absorption wavelength in the wavelength region of the light source used for light irradiation, for generating radicals efficiently through absorption of light energy. In the case where a component other than the photopolymerization initiator among the compounds contained in the over coat layer has absorption in this wavelength region, there are cases where the photopolymerization initiator cannot absorb sufficient energy, thereby reducing the radical generation efficiency. The ordinary binder resin, charge transporting material, and metal oxide particles have absorption wavelengths in the ultraviolet (UV) region, and therefore this effect becomes conspicuous in the case where the light source used for light irradiation emits ultraviolet (UV) light. From the standpoint of preventing the failure, an acylphosphine oxide based compound, which has an absorption wavelength on a relatively long wavelength side among the photopolymerization initiators, is preferably contained. The acylphosphine oxide based compound is preferred since the compound has the photobleaching effect, in which the absorption wavelength region is shifted to the low wavelength side through self cleavage, so as to allow light to permeate the interior of the over coat layer, resulting in good internal curability. In this case, a hydrogen abstraction type initiator is more preferably used in combination from the standpoint of supplementing the curability of the over coat layer surface. The content ratio of the hydrogen abstraction type initiator with respect to the acylphosphine oxide based compound is not particularly limited, is preferably 0.1 part by mass or more from the standpoint of supplementing the surface curability, and is preferably 5 parts by mass or less from the standpoint of retaining the internal curability, all per 1 part by mass of the acylphosphine oxide based compound.

A compound having a photopolymerization acceleration effect may be used alone or as a combination with the aforementioned photopolymerization initiator. Examples thereof include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

One kind of the polymerization initiator may be used, or two or more kinds thereof may be used by mixing. The content of the polymerization initiator may be 0.5 to 40 parts by mass, and preferably 1 to 20 parts by mass, per 100 parts by mass of the total amount of the contents having radical polymerizability.

(Formation Method of Over Coat Layer)

The formation method of the over coat layer will be described. The formation method of the over coat layer is not particularly limited, and for example, the over coat layer can be formed by coating a coating liquid having the binder resin, the charge transporting material, the metal oxide particles, and the other substances dissolved (or dispersed) in a solvent (or a dispersion medium) as the over coat layer.

The solvent or dispersion medium used for forming the over coat layer, and the coating method therefor will be described.

[Solvent Used in Coating Liquid for Forming Over Coat Layer]

The organic solvent used in the coating liquid for forming the over coat layer of the present invention may be any organic solvent that can dissolve the substances relating to the present invention. Specific examples thereof include an alcohol compound, such as methanol, ethanol, propanol, and 2-methoxyethanol; an ether compound, such as tetrahydrofuran, 1,4-dioxane, and dimethoxyethane; an ester compound, such as methyl formate and ethyl acetate; a ketone compound, such as acetone, methyl ethyl ketone, and cyclohexanone; an aromatic hydrocarbon compound, such as benzene, toluene, xylene, and anisole; a chlorinated hydrocarbon compound, such as dichloromethane, chloroform, 1,2-dichloroethane, 1,1,2-trichloroethane, 1,1,1-trichloroethane, tetrachloroethane, 1,2-dichloropropane, and trichloroethylene; a nitrogen-containing compound, such as n-butylamine, isopropanolamine, diethylamine, triethanolamine, ethylenediamine, and triethylenediamine; and an aprotic polar solvent, such as acetonitrile, N-methylpyrrolidone, N,N-dimethylformamide, and dimethylsulfoxide. A mixed solvent among these may be used as an optional combination at an optional ratio. An organic solvent that does not dissolve by itself the substances for the protective layer according to the invention may be used, for example, in the case where a mixed solvent with the aforementioned organic solvents can dissolve the substances. In general, the use of a mixed solvent can reduce the coating unevenness. In the case where a dip coating method is used as the coating method described later, it is preferred to select a solvent that does not dissolve the underlayer. From this standpoint, it is preferred to contain an alcohol compound, which has a low solubility to a polycarbonate and a polyarylate used preferably in the photosensitive layer.

The amount ratio of the organic solvent used in the coating liquid for forming the over coat layer of the present invention and the solid content therein may vary depending on the coating method of the coating liquid for forming the over coat layer, and may be used while being appropriately changed to form a uniform coated film by the coating method applied.

[Coating Method]

The coating method of the coating liquid for forming the over coat layer is not particularly limited, and examples thereof include a spray coating method, a spiral coating method, a ring coating method, and a dip coating method.

After forming the coated film by the coating method, the coated film is dried, at which the temperature and the period of time are not particularly limited, as far as necessary and sufficient dryness can be obtained. However, in the case where after the coating photosensitive layer, the over coat layer is coated and dried only by air drying, the layers are preferably dried sufficiently by the method described in the section [Coating Method] for the photosensitive layer described above.

The optimum thickness of the over coat layer may be appropriately selected depending on the materials used and the like, is preferably 0.1 μm or more, more preferably 0.2 μm or more, further preferably 0.8 μm or more, and particularly preferably 1.5 μm or more, from the standpoint of the lifetime, and is preferably 10 μm or less, more preferably 6 μm or less, and particularly preferably 3 μm or less, from the standpoint of the electric characteristics.

[Curing Method of Over Coat Layer]

The over coat layer may be formed in such a manner that the coating liquid is coated, and then cured by applying external energy so as to form a crosslinked surface layer. Examples of the external energy used herein include heat, light, and radiation, and light energy is preferred. As for the light energy an ultraviolet (UV) radiation light source having a light emission wavelength in UV light, such as a high pressure mercury lamp, a metal halide lamp, an electrodeless lamp bulb, and a light emitting diode, may be used, and a visible light source may also be selected corresponding to the absorption wavelength of the chain polymerizable compound and the photopolymerization initiator. The light amount is preferably 100 mJ/cm² or more and 20,000 mJ/cm² or less, more preferably 500 mJ/cm² or more and 10,000 mJ/cm² or less, and particularly preferably 1,000 mJ/cm² or more and 4,000 mJ/cm² or less. In the case where the light amount is less than 100 mJ/cm², the curing reaction cannot proceed sufficiently which results in insufficiency of the mechanical strength. In the case where the light amount exceeds 20,000 mJ/cm², the photosensitive layer may be deteriorated with excessive light energy to deteriorate the electric characteristics.

After curing the over coat layer, a heating process may be applied from the standpoint of the relaxation of the residual stress, the relaxation of the residual radicals, and the improvement of the electric characteristics. The heating temperature is preferably 60° C. or more and 200° C. or less, and more preferably 100° C. or more and 150° C. or less. In the case where the heating temperature is less than 60° C., the improvement effect may be poor, and in the case where the heating temperature exceeds 200° C., the photosensitive layer may be deteriorated to deteriorate the electric characteristics.

<Formation Method of Layers>

The layers constituting the photoreceptor may be formed by repeating a process of coating and drying a coating liquid obtained by dissolving or dispersing the substances to be contained in a solvent, on the conductive support by a known method, such as dip coating, spray coating, nozzle coating, bar coating, roll coating, or blade coating, for each of the layers.

The solvent or the dispersion medium used for producing the coating liquid is not particularly limited, and specific examples thereof include an alcohol compound, such as methanol, ethanol, propanol, and 2-methoxyethanol, an ether compound, such as tetrahydrofuran, 1,4-dioxane, and dimethoxyethane, an ester compound, such as methyl formate and ethyl acetate, a ketone compound, such as acetone, methyl ethyl ketone, cyclohexanone, 4-methox-4-methyl-2-pentanone, an aromatic hydrocarbon compound, such as benzene, toluene, and xylene, a chlorinated hydrocarbon compound, such as dichloromethane, chloroform, 1,2-dichloroethane, 1,1,2-trichloroethane, 1,1,1-trichloroethane, tetrachloroethane, 1,2-dichloropropane, and trichloroethylene, a nitrogen-containing compound, such as n-butylamine, isopropanolamine, diethylamine, triethanolamine, ethylenediamine, and triethylenediamine, and an aprotic polar solvent, such as acetonitrile, N-methylpyrrolidone, N,N-dimethylformamide, and dimethylsulfoxide. One kind thereof may be used alone, or two or more kinds thereof may be used in an optional combination.

The amount of the solvent or the dispersion medium used is not particularly limited, and in consideration of the purposes of the layers and the properties of the selected solvent or dispersion medium, it is preferred that the amount thereof used is appropriately regulated to make the solid concentration and the properties, such as the viscosity of the coating liquid within the desired ranges.

For the single layer type photoreceptor, for example, the solid concentration of the coating liquid is in a range of generally 5% by mass or more, and preferably 10% by mass or more, and generally 40% by mass or less, and preferably 35% by mass or less. The viscosity of the coating liquid at the temperature in use is in a range of generally 10 mPa·s or more, and preferably 50 mPa·s or more, and generally 2,000 mPa·s or less, preferably 1,000 mPa·s or less, more preferably 700 mPa·s or less, and further preferably 400 mPa·s or less.

In drying the coating liquid, after drying to touch, the coating liquid is preferably dried under heating in a rest state or under an air flow in a temperature range of generally 30° C. or more and 200° C. or less for a period of time of 1 minute to 2 hours. The heating temperature may be constant, or the drying operation may be performed by heating while changing the temperature.

<Cartridge and Image Formation Device>

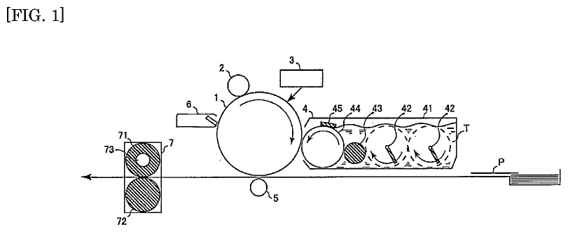

Embodiments of the image formation device using the electrophotographic photoreceptor of the present invention (i.e., the image formation device of the present invention) will be described with reference to FIG. 1 showing the structure of the main part of the device. The embodiments are not limited to the following description, and can be practiced with any modifications unless deviating from the substance of the present invention.

As shown in FIG. 1, the image formation device is constituted by including an electrophotographic photoreceptor 1, a charging device 2, an exposing device 3, and a developing device 4, and may further include a transferring device 5, a cleaning device 6, and a fixing device 7, depending on necessity.

The electrophotographic photoreceptor 1 is not particularly limited, as far as the electrophotographic photoreceptor of the present invention described above is used, and FIG. 1 shows, as one example thereof, a photoreceptor in a drum form including a cylindrical conductive support having formed on the surface thereof the photosensitive layer described above. Along the outer peripheral surface of the electrophotographic photoreceptor 1, the charging device 2, the exposing device 3, the developing device 4, the transferring device 5, and a cleaning device 6 are disposed.

The charging device 2 is for charging the electrophotographic photoreceptor 1, and uniformly charges the surface of the electrophotographic photoreceptor 1 to a prescribed potential. Examples of the general charging device include a non-contact corona charging device, such as corotron and scorotron, and a contact charging device (direct charging device) charging by bringing a charging member having a voltage applied thereto into contact with the surface of the photoreceptor, and in the present invention, a contact type charging roller may be used. FIG. 1 shows a roller type charging device (charging roller) as one example of the charging device 2. The charging roller is generally produced by molding a resin and an additive, such as a plasticizer, integrated with a metal shaft, and a laminated structure may be used depending on necessity.

The charging roller generally has a cylindrical outer shape having a diameter of 5 to 20 mm. In the case where the diameter of the charging roller is smaller than the range, there is a tendency that the accuracy in rotation is deteriorated, and in the case where the diameter thereof is larger than the range, a problem may occur in reducing the size and the weight in some cases. The diameter of the charging roller is preferably 7 mm or more, and more preferably 8 mm or more, and is preferably 18 mm or less, and more preferably 16 mm or less.

The charging roller used generally has a structure including a conductive core material having provided thereon an elastic layer. In the following description, the elastic layer refers to the part of the charging roller other than the conductive core material.

The conductive core material used is generally a metal. The material of the elastic layer provided on the core material is not particularly limited, as far as the material is semiconductive, and in general, may be a polymer composition, such as vulcanized or crosslinked rubber, a thermosetting resin, a photocuring resin, or a thermoplastic resin, applied with conductivity. Vulcanized or crosslinked rubber and a thermoplastic resin are preferred from the standpoint of the workability the flexibility and the like.

The vulcanized or crosslinked rubber is not particularly limited, examples of which include EPDM, polybutadiene, natural rubber, polyisoprene rubber, SBR, CR, NBR, silicone rubber, urethane rubber, and epichlorohydrin rubber, and the thermoplastic resin is not particularly limited, examples of which include a polyolefin series, a polystyrene series, a polyester series, a polyamide series, a polyurethane series, a polycarbonate, a fluorine series, and a silicone series.

In particular, a thermoplastic resin is preferred from the standpoint of the recycling efficiency reducing waste materials. A material having a low hardness is more preferred since the contact with the photoreceptor can be secured even when the elastic layer has a rough surface, so as to prevent charging unevenness from occurring. Accordingly among the thermoplastic resins, a soft material, such as a thermoplastic elastomer, is preferred. The thermoplastic elastomer is preferably a styrene based thermoplastic elastomer from the standpoint of the low hardness thereof, and is preferably an olefin based thermoplastic elastomer from the standpoint of the good releasability of the toner.

The voltage applied in charging is generally only a direct current voltage, and an alternating current superimposed on a direct current may also be used. In general, the damage on the photoreceptor is increased to cause abrasion by superimposing an alternating current voltage on a direct current voltage applied to the contact type charging roller, and therefore it is considered that the effect of the over coat layer introduced is larger in a direct current/alternating current superimposing system. However, a system using only a direct current voltage is preferred from the standpoint of the environmental load. It is considered that the benefit of the effect of enhancing the chargeability by introducing the over coat layer is larger in the system using only a direct current voltage.

The surface potential of the charged photoreceptor is generally +400 V or more, preferably +500 V or more, more preferably +600 V or more, further preferably +650 V or more, still further preferably +700 V or more, particularly preferably +750 V or more, and most preferably +800 V or more. The surface potential of the photoreceptor is preferably as high as possible from the standpoint of the contrast since the difference from the developing bias potential becomes larger.

The kind of the exposing device 3 is not particularly limited, as far as the exposing device exposes the electrophotographic photoreceptor 1 to form an electrostatic latent image on the photosensitive surface of the electrophotographic photoreceptor 1. Specific examples thereof include a halogen lamp, a fluorescent lamp, a laser, such as a semiconductor laser and a He—Ne laser, and an LED. The exposure may be performed by an internal exposure system of the photoreceptor. The light used in exposing may be optionally selected, and may be, for example, monochromatic light having a wavelength of 780 nm, monochromatic light having a wavelength of 600 nm to 700 nm on the slightly short wavelength side, monochromatic light having a wavelength of 380 nm to 500 nm on the short wavelength side, or the like.

The kind of a toner T as a developer may be optionally selected, and may be a powder toner, a polymerized toner using a suspension polymerization method or an emulsion polymerization method, or the like. In the case where the polymerized toner is used, in particular, a toner having a small particle diameter of 4 to 8 μm is preferred, and toner particles having various shapes including a shape close to sphere, and a bar shape deviated from sphere may be used. The polymerized toner is preferably used for enhancing the image quality since the toner is excellent in charging uniformity and transferability.

The kind of the transferring device 5 is not particularly limited, and devices of any system, for example, an electrostatic transferring method, such as corona transfer, roller transfer, and belt transfer, a pressure transferring method, an adhesive transferring method, may be used. It is assumed herein that the transferring device 5 is constituted by a transfer charger, a transfer roller, a transfer belt, or the like disposed to face the electrophotographic photoreceptor 1. The transferring device 5 applies a prescribed voltage value (transfer voltage) having a polarity reverse to the charging potential of the toner T, so as to transfer the toner image formed on the electrophotographic photoreceptor 1 to recording paper (paper or medium) P.

The cleaning device 6 is not particularly limited, and may be any cleaning device, such as a brush cleaner, a magnetic brush cleaner, an electrostatic brush cleaner, a magnetic roller cleaner, and a blade cleaner. The cleaning device 6 scrapes off the residual toner attached to the photoreceptor 1 with a cleaning member, so as to recover the residual toner. However, in the case where there is only a small amount of or substantially no toner remaining on the photoreceptor surface, the cleaning device 6 may be omitted.

An image is recorded in the following manner with the electrophotographic device constituted as above. Specifically, the surface (photosensitive surface) of the photoreceptor 1 is charged to a prescribed potential (for example, 600 V) with the charging device 2. At this time, the photosensitive surface may be charged with a direct current voltage or may be charged by superimposing an alternating current voltage on a direct current voltage.

Subsequently the charged photosensitive surface of the photoreceptor 1 is exposed with the exposing device 3 according to the image to be recorded, so as to form an electrostatic latent image on the photosensitive surface. The electrostatic latent image formed on the photosensitive surface of the photoreceptor 1 is then developed with the developing device 4.

The developing device 4 thins the toner T supplied with a supplying roller 43 with a restricting member (developing blade) 45, frictionally charges the toner to the prescribed polarity (herein the positive polarity which is the same polarity as the charging potential of the photoreceptor 1), conveys the toner by carrying on a developing roller 44, and brings the toner into contact with the surface of the photoreceptor 1.

By bringing the charged toner T carried on the developing roller 44 into contact with the surface of the photoreceptor 1, a toner image corresponding to the electrostatic latent image is formed on the photosensitive surface of the photoreceptor 1. The toner image is then transferred to recording paper P with the transferring device 5. Thereafter, the toner remaining on the photosensitive surface of the photoreceptor 1 but not being transferred is removed with the cleaning device 6.

After transferring the toner image to the recording paper P, the toner image is thermally fixed on the recording paper P by passing through the fixing device 7, resulting in the final image.

The image formation device may include, for example, a configuration capable of performing a destaticizing step, in addition to the aforementioned configuration. The destaticizing step is to destaticize the electrophotographic photoreceptor by exposing the electrophotographic photoreceptor, and the destaticizing device used may be a fluorescent lamp, an LED, or the like. As for the intensity of the light used in the destaticizing step, light having exposure energy that is three times or more the exposure light may be frequently used. The destaticizing step is preferably not used from the standpoint of the reduction in size and the energy saving.

The image formation device may be constituted by further modifying, and for example, may have a configuration capable of performing steps, such as a preexposure step and an auxiliary charging step, may have a configuration performing offset printing, and may have a configuration of a full-color tandem system using multiple kinds of toners.

The electrophotographic photoreceptor 1 may be combined with one component or two or more components of the charging device 2, the exposing device 3, the developing device 4, the transferring device 5, the cleaning device 6, and the fixing device 7, so as to be constituted as an integrated cartridge (which may be hereinafter referred to as an “electrophotographic photoreceptor cartridge”), and a configuration in which the electrophotographic photoreceptor cartridge is detachable to an electrophotographic device, such as a duplicator and a laser beam printer, may be constituted.

### EXAMPLES

Embodiments of the present invention will be described more specifically with reference to examples below. However, the examples below are shown for describing the present invention in detail, and the present invention is not limited to the examples below unless the substance thereof is deviated, and may be practiced with optional modifications. In Examples and Comparative Examples below, the “part” means a “part by mass” unless otherwise indicated.

<Production of Electrophotographic Photoreceptor>

### Example 1

10 parts by mass of Y-type oxytitanium phthalocyanine was added to 150 parts by mass of 1,2-dimethoxyethane, and subjected to a pulverization and dispersion treatment with a sand grinder mill, so as to produce a pigment dispersion liquid. 160 parts by mass of the pigment dispersion liquid thus obtained was added to 100 parts by mass of a 5% by mass 1,2-dimethoxyethane solution of polyvinyl butyral (#6000C, a trade name, available from Denka Co., Ltd.) and a suitable amount of 4-methoxy-4-methyl-2-pentanone, so as to produce a coating liquid for forming an undercoating layer having a final solid concentration of 4.0% by mass. The coating liquid for forming an undercoating layer was coated on a cylinder formed of an aluminum alloy having an outer diameter of 30 mm, a length of 340 mm, and a thickness of 0.75 mm having a roughly cut surface by dipping the cylinder in the coating liquid, so as to form an undercoating layer having a film thickness of 0.3 μm after drying.

Subsequently 2.2 parts by mass of Y-type oxytitanium phthalocyanine and 1.1 parts by mass of a perylene pigment shown by the following structural formula (PIG-1) were mixed and dispersed with 81 parts by mass of toluene with a sand grinder mill. A 10% tetrahydrofuran solution having 0.5 part by mass of a butyral resin (Mowital B14S, a product name, available from Kuraray Co., Ltd.) dissolved therein was mixed with the resulting dispersion liquid, and agitated to prepare a pigment dispersion liquid. Separately 70 parts by mass of the hole transporting material shown by the following structural formula (H-1), 50 parts by mass of the electron transporting material shown by the following structural formula (E-1), and 100 parts by mass of a polycarbonate resin shown by the following structural formula (B-1) [viscosity average molecular weight Mv: 60,000] were dissolved in a mixed solvent of 565 parts by mass of tetrahydrofuran and 61 parts by mass of toluene, to which 0.05 part of a silicone oil was added as a leveling agent, and the pigment dispersion liquid prepared above was added thereto, followed by uniformly mixing the mixture with a homogenizer, so as to prepare a coating liquid for forming a single layer photosensitive layer. The coating liquid for forming a single layer photosensitive layer thus prepared was coated on the undercoating layer to a film thickness of 34 μm after drying, and subjected to air drying at 100° C. for 24 minutes, so as to produce a single layer type photoreceptor before coating an over coat layer.

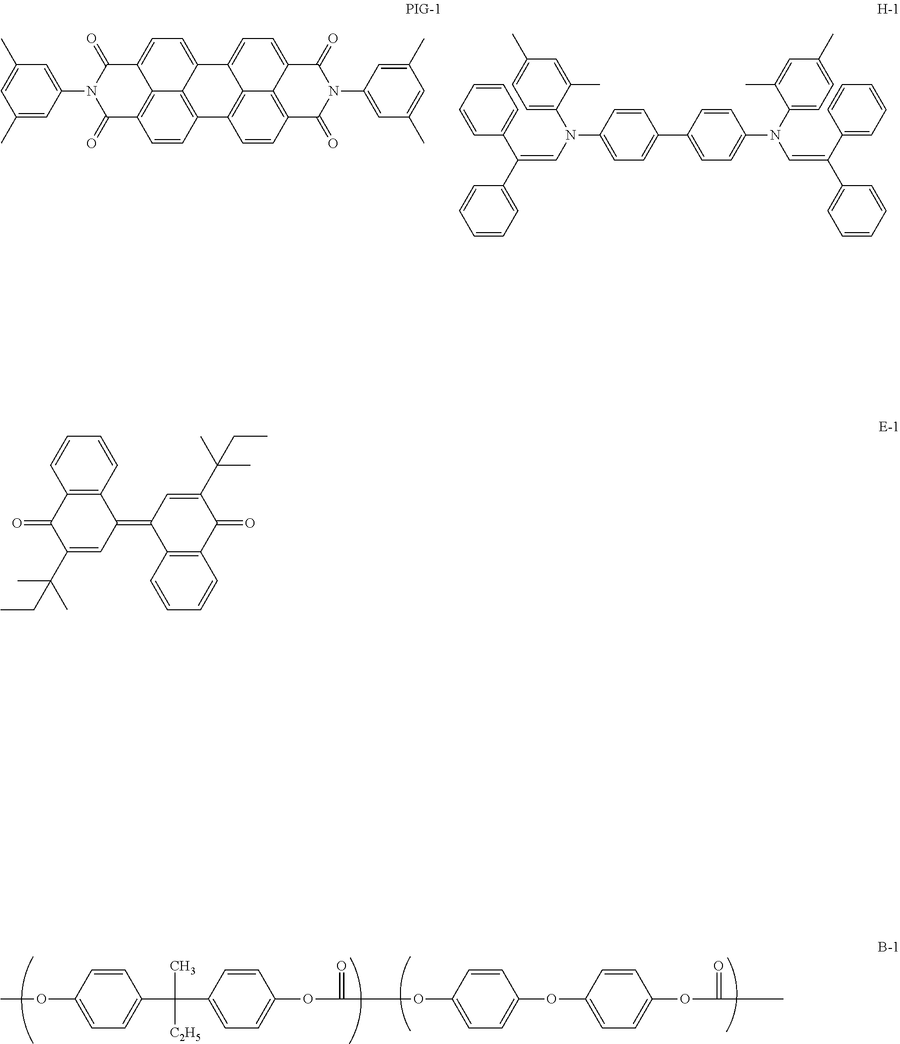

<Formation of Over Coat Layer>

Surface-treated titanium oxide obtained by mixing titanium oxide (TTO55N, a product name, rutile type titania, available from Ishihara Sangyo Kaisha, Ltd.) and 7% by mass (5% by mass+2% by mass), which is based on the titanium oxide, of 3-methacryloxypropyltrimethoxysilane (KBM-503, available from Shin-Etsu Chemical Co., Ltd.) with a Henschel mixer was dispersed in a methanol solvent with UAM-015 (a bead mill device, available from Hiroshima Metal & Machinery Co., Ltd.), so as to provide a dispersion slurry (solvent: methanol) having a solid concentration of the surface-treated titania of 25% by mass. The dispersion slurry a mixed solvent of methanol and 1-propanol, 100 parts by mass of an acrylic monomer, UV6300B (available from Mitsubishi Chemical Corporation), 1 part by mass of benzophenone, and 2 parts by mass of diphenyl(2,4,6-trimethylbenzoyl)phosphineoxide were mixed and agitated to dissolve the solid contents, and then subjected to an ultrasonic dispersion treatment, so as to produce a coating liquid for forming an over coat layer having a solid concentration of 15.0% having a mass ratio of methanol/1-propanol of 7/3 and a mass ratio of acrylic monomer/surface-treated titanium oxide of 1/0.6. The coating liquid was dip-coated on the single layer type photoreceptor before coating an over coat layer, and dried at 100° C. for 10 minutes. The protective layer was cured through irradiation of UV light from the surface side thereof with an UV light irradiation device equipped with an electrodeless lamp bulb (D bulb) to a light amount of 8,000 mJ/cm², so as to form an over coat layer (O-1) having a thickness of 1 μm, and thus a single layer type photoreceptor (X-1) was obtained.

### Examples 2 to 4

Photoreceptors (X-2), (X-3), and (X-4) each were produced by performing the same procedure as in Example 1 except that the film thickness of the over coat layer was as shown in Table 1.

### Example 5

A photoreceptor (X-5) was produced by performing the same procedure as in Example 1 except that an over coat layer (0-2) was formed by changing the content ratio by mass of acrylic monomer/surface-treated titanium oxide to 1/1.

### Example 6

A photoreceptor (X-6) was produced by performing the same procedure as in Example 1 except that an over coat layer (0-3) was formed by changing the content ratio by mass of acrylic monomer/surface-treated titanium oxide to ½.

### Example 7

A photoreceptor (X-7) was produced by performing the same procedure as in Example 1 except that an over coat layer (0-4) was formed by changing the content ratio by mass of acrylic monomer/surface-treated titanium oxide to 1/0.2.

### Example 8

A photoreceptor (X-8) was produced by performing the same procedure as in Example 1 except that the single layer type photoreceptor before coating an over coat layer was produced by changing the amount of the hole transporting material shown by the structural formula (H-1) to 100 parts by mass and the amount of the electron transporting material shown by the structural formula (E-1) to 60 parts by mass.

### Example 9

A photoreceptor (X-9) was produced by performing the same procedure as in Example 1 except that the single layer type photoreceptor before coating an over coat layer was produced by changing the amount of the hole transporting material shown by the structural formula (H-1) to 90 parts by mass and the amount of the electron transporting material shown by the structural formula (E-1) to 70 parts by mass, and further adding 40 parts by mass of the electron transporting material shown by the following structural formula (E-2).

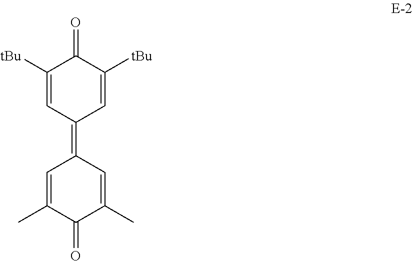 [SMILES: CC1=CC(=C2C=C(C(C)(C)C)C(=O)C(C(C)(C)C)=C2)C=C(C)C1=O]

### Example 10

A photoreceptor (X-10) was produced by performing the same procedure as in Example 1 except that the single layer type photoreceptor before coating an over coat layer was produced by changing the amount of the hole transporting material shown by the structural formula (H-1) to 90 parts by mass and the amount of the electron transporting material shown by the structural formula (E-1) to 70 parts by mass, and further adding 40 parts by mass of the electron transporting material shown by the structural formula (E-2) and 30 parts by mass of tribenzylamine (A-1) as an additive.

### Example 11

A photoreceptor (X-11) was produced by performing the same procedure as in Example 1 except that an over coat layer (0-5) was formed by changing the surface-treated titanium oxide to phosphorus-doped tin oxide (phosphorus-doped tin oxide nanopowder, SP-2, a product name, available from Mitsubishi Materials Electronic Chemicals Co., Ltd.).

### Example 12

A photoreceptor (X-12) was produced by performing the same procedure as in Example 1 except that the binder resin of the single layer type photoreceptor before coating an over coat layer was changed to a polycarbonate resin shown by the following structural formula (B-2) [viscosity average molecular weight Mv: 50,000].

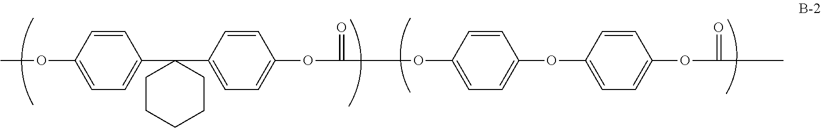

### Example 13

A photoreceptor (X-13) was produced by performing the same procedure as in Example 1 except that the binder resin of the single layer type photoreceptor before coating an over coat layer was changed to a polycarbonate resin shown by the following structural formula (B-3) [viscosity average molecular weight Mv: 60,000].

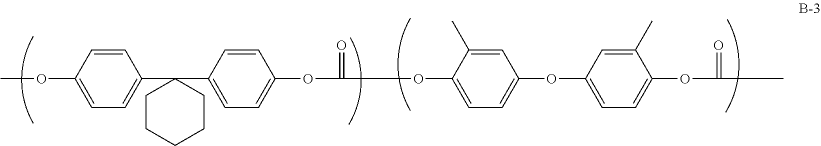

### Example 14

A photoreceptor (X-14) was produced by performing the same procedure as in Example 1 except that the binder resin of the single layer type photoreceptor before coating an over coat layer was changed to a polyarylate resin shown by the following structural formula (B-4) [viscosity average molecular weight Mv: 43,000].

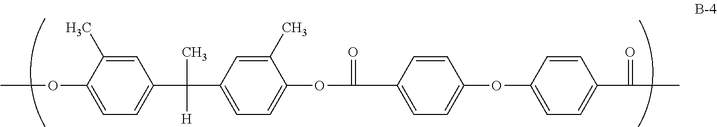

### Comparative Example 1

A single layer type photoreceptor before coating an over coat layer of Example 1 was produced by performing the same procedure as in Example 1 except that the over coat layer was not formed, and designated as a photoreceptor (Y-1).

### Comparative Example 2

A single layer type photoreceptor before coating an over coat layer of Example 8 was produced by performing the same procedure as in Example 8 except that the over coat layer was not formed, and designated as a photoreceptor (Y-2).

### Comparative Example 3

A single layer type photoreceptor before coating an over coat layer of Example 9 was produced by performing the same procedure as in Example 9 except that the over coat layer was not formed, and designated as a photoreceptor (Y-3).

### Comparative Example 4

A single layer type photoreceptor before coating an over coat layer of Example 10 was produced by performing the same procedure as in Example 10 except that the over coat layer was not formed, and designated as a photoreceptor (Y-4).

### Comparative Example 5

Dispersion Liquid for forming Over Coat Layer 1

A dispersion liquid for forming an over coat layer was produced in the following manner. Specifically rutile type titanium oxide having an average primary particle diameter of 40 nm (TTO55N, available from Ishihara Sangyo Kaisha, Ltd.) and 3% by mass, which is based on the titanium oxide, of methyldimethoxysilane (TSL8117, available from Toshiba Silicone Co., Ltd.) were placed in a high-speed fluidized mixer kneader (SMG300, available from Kawata Mfg. Co., Ltd.). Surface-treated titanium oxide obtained through high-speed mixing at a rotation circumferential velocity of 34.5 m/sec was dispersed in a mixed solvent having a weight ratio of methanol/1-propanol of 7/3 with a ball mill, so as to provide a dispersion slurry of hydrophobic treated titanium oxide. The dispersion slurry a mixed solvent of methanol/1-propanol/toluene, and pellets of a copolymer polyamide having a compositional molar ratio of ε-caprolactam, bis(4-amino-3-methylcyclohexyl)methane, hexamethylenediamine, decamethylenedicarboxylic acid, and octadecamethylenedicarboxylic acid of 60%/15%/5%/15%/5% were agitated and mixed under heating to dissolve the polyamide pellets. Thereafter, the mixture was subjected to an ultrasonic dispersion treatment, so as to produce a dispersion liquid for forming an over coat layer 1 having a solid concentration of 18.0% having a weight ratio of methanol/1-propanol/toluene of 7/1/2 and a weight ratio of hydrophobic treated titanium oxide/copolymer polyamide of 3/1.

The dispersion liquid for forming an over coat layer thus produced was dip-coated on a single layer type photoreceptor before coating an over coat layer produced in the same manner as in Example 1, and dried at 100° C. for 24 minutes, so as to provide an over coat layer (O-6) having a film thickness of 1 μm, and thus a photoreceptor (Y-5) was produced.

### Comparative Example 6

A photoreceptor (Y-6) was produced by performing the same procedure as in Comparative Example 5 except that an over coat layer (O-7) was formed by changing the weight ratio of hydrophobic treated titanium oxide/copolymer polyamide to 1/1.

The compositions of the photoreceptors used in Examples and Comparative Examples are shown in Table 1.

TABLE 1

| | | | | Hole | | Electron | | | | | |
|---|---|---|---|---|---|---|---|---|---|---|---|
| | | | | transporting | | transporting | | | | | Film |
| | | Binder resin | | material | | material | | Additive | | | thickness |
| | Photoreceptor | Kind | Part | Kind | Part | Kind | Part | Kind | Part | OCL | (μm) |
| Example 1 | X-1 | B-1 | 100 | H-1 | 70 | E-1 | 50 | — | — | O-1 | 1 |
| Example 2 | X-2 | B-1 | 100 | H-1 | 70 | E-1 | 50 | — | — | O-1 | 0.5 |
| Example 3 | X-3 | B-1 | 100 | H-1 | 70 | E-1 | 50 | — | — | O-1 | 2 |
| Example 4 | X-4 | B-1 | 100 | H-1 | 70 | E-1 | 50 | — | — | O-1 | 4 |
| Example 5 | X-5 | B-1 | 100 | H-1 | 70 | E-1 | 50 | — | — | O-2 | 1 |
| Example 6 | X-6 | B-1 | 100 | H-1 | 70 | E-1 | 50 | — | — | O-3 | 1 |
| Example 7 | X-7 | B-1 | 100 | H-1 | 70 | E-1 | 50 | — | — | O-4 | 1 |
| Example 8 | X-8 | B-1 | 100 | H-1 | 100 | E-1 | 60 | — | — | O-1 | 1 |
| Example 9 | X-9 | B-1 | 100 | H-1 | 90 | E-1 | 70 | — | — | O-1 | 1 |
| | | | | | | E-2 | 40 | | | | |
| Example 10 | X-10 | B-1 | 100 | H-1 | 90 | E-1 | 70 | A-1 | 30 | O-1 | 1 |
| | | | | | | E-2 | 40 | | | | |
| Example 11 | X-11 | B-1 | 100 | H-1 | 70 | E-1 | 50 | — | — | O-5 | 1 |
| Example 12 | X-12 | B-2 | 100 | H-1 | 70 | E-1 | 50 | — | — | O-1 | 1 |
| Example 13 | X-13 | B-3 | 100 | H-1 | 70 | E-1 | 50 | — | — | O-1 | 1 |
| Example 14 | X-14 | B-4 | 100 | H-1 | 70 | E-1 | 50 | — | — | O-1 | 1 |
| Comparative | Y-1 | B-1 | 100 | H-1 | 70 | E-1 | 50 | — | — | — | — |
| Example 1 | | | | | | | | | | | |
| Comparative | Y-2 | B-1 | 100 | H-1 | 100 | E-1 | 60 | — | — | — | — |
| Example 2 | | | | | | | | | | | |
| Comparative | Y3 | B-1 | 100 | H-1 | 90 | E-1 | 70 | — | — | — | — |
| Example 3 | | | | | | E-2 | 40 | | | | |
| Comparative | Y-4 | B-1 | 100 | H-1 | 90 | E-1 | 70 | A-1 | 30 | — | — |
| Example 4 | | | | | | E-2 | 40 | | | | |
| Comparative | Y5 | B-1 | 100 | H-1 | 70 | E-1 | 50 | — | — | O-6 | 1 |
| Example 5 | | | | | | | | | | | |
| Comparative | Y6 | B-1 | 100 | H-1 | 70 | E-1 | 50 | — | — | O-7 | 1 |
| Example 6 | | | | | | | | | | | |

### Evaluation of Photoreceptors of Examples 1 to 14 and Comparative Examples 1 to 6

### <Evaluation of Chargeability>

The photoreceptors (X-1) to (X-14) and (Y-1) to (Y-6) each were charged under an environment of 32° C. and 85% RH with the following charging means while rotating the photoreceptor at 200 rpm, in which after starting the voltage application to the charging means, the surface potential at the first rotation of the photoreceptor was designated as Vcyc1, and the surface potential at the tenth rotation thereof was designated as Vcyc10. At this time, the period of time from charging to the potential measurement was 90 msec. The voltage was applied to make Vcyc10 of +850 V and the chargeability was evaluated according to the following expression.

Chargeability (%)=(Vcyc1/Vcyc10)×100(%)

In the expression, a larger value in terms of percentage means that the target charge potential is achieved immediately after starting the charge, and the charge is easily performed. The results are shown in Table 2.

-Charging Means-

The means used for uniformly charging the circumferential surface of the electrophotographic photoreceptor was a charging roller (roller charger) having a diameter of 8 mm. The charging roller was rotatably retained at both ends of the core metal with bearing members respectively was brought into pressure contact with the surface of the electrophotographic photoreceptor under a prescribed pressing force by pressing toward the electrophotographic photoreceptor with a thrust spring, and was rotated following the rotation of the electrophotographic photoreceptor. The core metal of the charging roller was applied with a charge bias voltage under a prescribed condition, and thereby the circumferential surface of the rotating photosensitive drum was subjected to a contact charging treatment to prescribed polarity and potential.

<Evaluation of Electric Characteristics>

By using an electrophotographic characteristics evaluation device produced according to the measurement standard of Soc. of Electrophotography of Japan (described in Fundamentals and Application of Electrophotographic Technology Part 2, edited by Soc. of Electrophotography of Japan, CORONA PUBLISHING CO., LTD., pp. 404-405), the photoreceptor was rotated at 200 rpm, and charged with a contact type charging roller to make an initial surface potential of +850 V, and with monochromatic light of 780 nm obtained by filtering light from a halogen lamp with a dichroic filter, the attenuation behavior of the surface potential was measured by changing the light amount of the monochromatic light with ND filters having different transmittances. At this time, after exposing at each of the light amounts, most of the residual potential was cancelled by exposing to LED light of 660 nm as destaticizing light. As the measurement value, the surface potential after exposing to monochromatic light of 780 nm to 0.7 μJ/cm² (VL1, bright potential) was obtained. In the VL measurement, the period of time required from exposure to potential measurement was 30 msec. The measurement environment was a temperature of 10° C. and a relative humidity of 15%. The measurement results are shown in Table 2.

<Evaluation of Leak Characteristics>

The photoreceptors (X-1) to (X-14) and (Y-1) to (Y-6) each were evaluated for the leak characteristics by being subjected to the following cycle process of charging, potential measurement, and destaticization, under an environment of a temperature of 32° C. and a humidity of 80%. Specifically, the photoreceptor mounted on an electrophotographic characteristics evaluation device produced according to the measurement standard of Soc. of Electrophotography of Japan (described in Fundamentals and Application of Electrophotographic Technology Part 2, edited by Soc. of Electrophotography of Japan, CORONA PUBLISHING CO., LTD., pp. 404-405) was charged to make an initial surface potential of +850 V and the surface potential thereof was measured. At this time, the charging (contact type roller charging) condition was fixed to make an initial surface potential of the photoreceptor of +850 V in the initial stage of the test. The period of time from exposure to potential measurement was high speed of 30 msec.

While the photoreceptor was rotated at a constant rotation number of 200 rpm, the cycle of charging, potential measurement, and destaticization was repeated 100,000 times, and then the photoreceptor surface was observed to determine the presence of leak marks. The evaluation results are shown by the following expression in Table 2.

A: No leak mark, good

B: Slight leak marks

C: many leak marks

<Evaluation of Gas Resistance>

The photoreceptors (X-1) to (X-14) and (Y-1) to (Y-6) each were evaluated for the gas resistance by being subjected to the following cycle process of charging, potential measurement, and destaticization, under an environment of 32° C. and 85% RH. Specifically the photoreceptor mounted on an electrophotographic characteristics evaluation device produced according to the measurement standard of Soc. of Electrophotography of Japan (described in Fundamentals and Application of Electrophotographic Technology Part 2, edited by Soc. of Electrophotography of Japan, CORONA PUBLISHING CO., LTD., pp. 404-405) was charged to make an initial surface potential of +850 V, and the surface potential thereof was measured. At this time, the period of time from exposure to potential measurement was high speed of 30 msec. While the photoreceptor was rotated at a constant rotation number of 200 rpm, the cycle of charging, potential measurement, and destaticization was repeated 70,000 times, and the observed surface potential (V0) was measured. At this time, the charging (scorotron charging device) condition was fixed to make an initial surface potential of the photoreceptor of +850 V in the initial stage of the test. Assuming that the surface potential in the initial stage of the test was V0-ini, and the surface potential after repeating the cycle process 70,000 times was V0-70 k, the extent of decrease of the surface potential of the photoreceptor caused by the gas and the ionic substances generated from the scorotron charger was expressed by (surface potential retention rate (%))=((V0−70 k)/(V0-ini))×100(%) and designated as the evaluation of the gas resistance. A larger value means that the surface potential is retained and not changed before and after the cyclic test. The results are shown in Table 2.

In the evaluation, the gas resistance was evaluated under the severer condition by using the scorotron charging system generating a larger amount of gas than the contact roller charging system.

TABLE 2

| | | | | Surface |
|---|---|---|---|---|
| | | | Evaluation | potential |
| | Chargeability | VL1 | result of | retention rate |
| | (%) | (V) | leak | (%) |
| Example 1 | 93.1 | 150 | A | 71.6 |
| Example 2 | 94.7 | 145 | A | 67.1 |
| Example 3 | 94.4 | 158 | A | 72.9 |
| Example 4 | 94.6 | 175 | A | 73.2 |
| Example 5 | 93.9 | 147 | A | 71.2 |
| Example 6 | 94.4 | 144 | A | 70.9 |
| Example 7 | 93.6 | 188 | A | 73.8 |
| Example 8 | 95.3 | | A | 75.6 |
| Example 9 | 94.4 | | A | 91.4 |
| Example 10 | 97.8 | | A | 98.1 |
| Example 11 | 94.3 | 134 | A | 70.2 |
| Example 12 | 93.8 | | A | 83.3 |
| Example 13 | 93.6 | | A | 81.0 |
| Example 14 | 94.6 | | A | 76.5 |
| Comparative | 85.8 | | B | 39.0 |
| Example 1 | | | | |
| Comparative | 89.7 | | C | 41.1 |
| Example 2 | | | | |
| Comparative | 87.7 | | C | 46.4 |
| Example 3 | | | | |
| Comparative | 91.3 | | C | 63.4 |
| Example 4 | | | | |
| Comparative | 93.8 | 156 | C | 72.2 |
| Example 5 | | | | |
| Comparative | 95.0 | 215 | C | 71.0 |
| Example 6 | | | | |

The following matters are understood from Table 2.

It is understood from the evaluation results of the chargeability and the electric characteristics that the image formation device having the configuration of the present invention is excellent in chargeability and electric characteristics.

It is understood from the evaluation results of the electric characteristics (VL1) that in the case where the content of titanium oxide in the over coat layer is constant, the use of the photoreceptor using the over coat layer (O-2) containing the cured product formed by curing the curable compound can provide excellent electric characteristics, as compared to that using the over coat layer (o-7) containing the polyamide.

It is understood from the evaluation results of the leak characteristics that the photoreceptor having the over coat layer containing the cured product formed by curing the curable compound generates no leak mark, and has a largely enhanced leak resistance, even with a contact charging system. Leak marks may cause image defects having streaky image noise occurring in the form corresponding to the longitudinal direction of the photoreceptor including the leak part, and therefore it is considered that the image formation device of the present invention using a photoreceptor having a high leak resistance causing no leak mark on the photoreceptor can produce images having no image defect due to leak for the period corresponding to the lifetime of the photoreceptor.

It is understood from the evaluation results of the gas resistance (surface potential retention rate) that the electrophotographic photoreceptor of the present invention can have a sufficiently enhanced gas resistance even through the photoreceptor is applied to the scorotron charging system generating a larger amount of gas than the contact roller charging system.

<Evaluation of Withstand Voltage>

The photoreceptors (X-1) and (Y-1) each were evaluated for the withstand voltage by being subjected to the following cycle process of charging and potential measurement under an environment of a temperature of 25° C. and a humidity of 50%. Specifically the photoreceptor mounted on an electrophotographic characteristics evaluation device produced according to the measurement standard of Soc. of Electrophotography of Japan (described in Fundamentals and Application of Electrophotographic Technology Part 2, edited by Soc. of Electrophotography of Japan, CORONA PUBLISHING CO., LTD., pp. 404-405) was rotated at a constant rotation number of 200 rpm and charged by changing the voltage applied to the contact roller charger to 1.1 kV, 1.35 kV, and 1.6 kV, and the potential of the photoreceptor surface and the electric current flowing in the photoreceptor (inflow current) were measured. At this time, the period of time from exposure to potential measurement was high speed of 30 msec. A smaller value of the inflow current means excellent withstand voltage. The evaluation results are shown in Table 3.

TABLE 3

| | | | | Applied voltage: | | Applied voltage: | | Applied voltage: | |
|---|---|---|---|---|---|---|---|---|---|
| | | | | 1.1 kV | | 1.35 kV | | 1.6 kV | |
| | | | Film | Surface | Inflow | Surface | Inflow | Surface | Inflow |
| | | | thickness | potential | current | potential | current | potential | current |
| | Photoreceptor | OCL | (μm) | (V) | (μA) | (V) | (μA) | (V) | (μA) |
| Example 1 | X-1 | O-1 | 1 | 456 | 0.89 | 683 | 1.16 | 903 | 1.74 |
| Comparative | Y-1 | — | — | 439 | 0.92 | 668 | 1.50 | 900 | 2.37 |
| Example 1 | | | | | | | | | |

| | | | |
|---|---|---|---|
| Ratio of inflow current | 96.7 | 77.3 | 73.4 |
| X-1/Y-1 (%) | | | |

It is understood from the results of Table 3 that in the case where the applied voltage is increased, i.e., in the case where the surface potential of the photoreceptor is increased, the difference of the inflow current caused by the presence of the over coat layer containing the cured product formed by curing the curable compound is increased. Specifically, it is understood therefrom that the enhancement of the withstand voltage characteristics obtained by introducing the over coat layer containing the cured product formed by curing the curable compound becomes more conspicuous when the surface potential of the photoreceptor is higher, and in particular, it is useful when the photoreceptor is charged to +600 V or more.

For enhancing the contrast of printed images, it is effective to increase the applied voltage to increase the surface potential of the photoreceptor. Accordingly it is considered that the image formation device having the configuration of the present invention excellent in withstand voltage characteristics even when the applied voltage is increased is advantageous for printing images with favorable contrast.

<Production of Photoreceptor Sheet>

### Example 15

The coating liquid for forming an undercoating layer produced in Example 1 was coated on a polyethylene terephthalate sheet having aluminum vapor-deposited on the surface thereof, to a film thickness of 0.4 μm after drying, and dried to form an undercoating layer.

Subsequently the coating liquid for forming a single layer photosensitive layer produced in Example 1 was coated with an applicator on the undercoating layer, to a film thickness of 30 μm after drying, and dried at 100° C. for 24 minutes to produce a single layer type photoreceptor sheet before coating an over coat layer.

Subsequently the coating liquid for forming an over coat layer produced in Example 1 was coated with a wire bar on the photosensitive layer to a film thickness of 1 μm after drying. The photoreceptor sheet was dried at 100° C. for 10 minutes, and then the over coat layer was cured through irradiation of UV light from the surface side thereof with a UV light irradiation device equipped with an electrodeless lamp bulb (D bulb) to a light amount of 8,000 mJ/cm², so as to produce a photoreceptor sheet having a photosensitive layer of 30 μm having thereon an over coat layer of 1 μm. The resulting photoreceptor sheet was designated as (SX-1).

### Comparative Example 7

A single layer type photoreceptor sheet before coating an over coat layer of Example 15 was produced by performing the same procedure as in Example 15 except that the over coat layer was not formed, and designated as a photoreceptor sheet (SY-1).

### Comparative Example 8

The dispersion liquid for forming an over coat layer used in Comparative Example 6 was coated with a wire bar on a single layer type photoreceptor sheet before coating an over coat layer that was produced in the same manner as in Example 15, to a film thickness of 1 μm after drying. The photoreceptor sheet was dried at 100° C. for 10 minutes to form an over coat layer having a film thickness of 1 μm, and thus a photoreceptor sheet (SY-2) was produced.

<Evaluation of Abrasion Resistance>

The photoreceptor sheets (SX-1), (SY-1), and (SY-2) each were cut into a circular shape having a diameter of 10 cm, and subjected to evaluation of abrasion with a Taber abrasion tester (available from Toyo Seiki Seisaku-sho, Ltd.). As the test condition, under an environment of 25° C. and 50% RH, the abrasion amount after rotating the abrasion ring CS-10F 700 times under a load of 1,000 g was measured by comparing masses before and after the test. A smaller value means better abrasion resistance. The results are shown in Table 4. The evaluation herein simulates the evaluation of the abrasion resistance of the photoreceptor used in a contact roller charging type image formation device.

TABLE 4

| | | Binder | | Hole transporting | | Electron transporting | | | Film | Abrasion |
|---|---|---|---|---|---|---|---|---|---|---|
| | | resin | | material | | material | | | thickness | test |
| | Photoreceptor | Kind | Part | Kind | Part | Kind | Part | OCL | (μm) | (mg) |
| Example 15 | SX-1 | B-1 | 100 | H-1 | 70 | E-1 | 50 | O-1 | 1 | 3.88 |
| Comparative | SY-1 | B-1 | 100 | H-1 | 70 | E-1 | 50 | — | — | 15.14 |
| Example 7 | | | | | | | | | | |
| Comparative | SY-2 | B-1 | 100 | H-1 | 70 | E-1 | 50 | O-7 | 1 | 10.91 |
| Example 8 | | | | | | | | | | |

It is understood from the results of SX-1 and SY-1 in Table 4 that the over coat layer (O-1) of the present invention containing the cured product formed by curing the curable compound largely enhances the abrasion resistance of the photoreceptor. It is also understood that the enhancement effect of the abrasion resistance is larger than the effect by the over coat layer (O-7) containing the polyamide.

### REFERENCE SIGN LIST

1: Electrophotographic photoreceptor
2: Charging device
3: Exposing device
4: Developing device
5: Transferring device
6: Cleaning device
7: Fixing device

1. An image formation device comprising (i) an electrophotographic photoreceptor and (ii) a contact charging system,
wherein the electrophotographic photoreceptor comprises a positively charging electrophotographic photoreceptor including: a single layer photosensitive layer containing a binder resin, a charge generating material, a hole transporting material, and an electron transporting material; and an over coat layer containing a cured product formed by curing a curable compound.

2. The image formation device according to claim 1, wherein the curable compound comprises a photocurable compound.

3. The image formation device according to claim 1, wherein the contact charging system is a contact roller charging system.

4. An image formation device comprising (i) an electrophotographic photoreceptor and (ii) a contact roller charging system,
wherein the electrophotographic photoreceptor comprises a positively charging electrophotographic photoreceptor including: a single layer photosensitive layer containing a binder resin, a charge generating material, a hole transporting material, and an electron transporting material; and an over coat layer containing a cured product formed by curing a photocurable compound.

5. The image formation device according to claim 1, wherein the over coat layer contains metal oxide particles.

6. The image formation device according to claim 5, wherein a content ratio (mass ratio) of the metal oxide particles of with respect to the curable compound is 0.5 or more.

7. The image formation device according to claim 5, wherein the single layer photosensitive layer contains 30 parts by mass or more of the electron transporting material per 100 parts by mass of the binder resin.

8. The image formation device according to claim 1, wherein the single layer photosensitive layer contains 70 parts by mass or more of the hole transporting material per 100 parts by mass of the binder resin.

9. The image formation device according to claim 1, wherein the single layer photosensitive layer contains 1.0 part by mass or more of the charge generating material per 100 parts by mass of the binder resin.

10. The image formation device according to claim 1, wherein the over coat layer has a thickness of 0.2 μm or more and 6 μm or less.

11. The image formation device according to claim 1, wherein the single layer photosensitive layer contains tribenzylamine.

12. The image formation device according to claim 1, wherein the contact charging system is a contact charging system applying only a direct current voltage.

13. An image formation method using an image formation device including (i) an electrophotographic photoreceptor and (ii) a contact charging device, the electrophotographic photoreceptor including: a single layer photosensitive layer containing a binder resin, a charge generating material, a hole transporting material, and an electron transporting material; and an over coat layer containing a cured product formed by curing a curable compound, the image formation method comprising:
charging positively the electrophotographic photoreceptor, and
developing with a developer.

14. The image formation method according to claim 13, wherein the curable compound comprises a photocurable compound.

15. The image formation method according to claim 13, wherein the image formation device comprises a contact charging roller.

16. The image formation method according to claim 13, wherein the charging positively the electrophotographic photoreceptor comprises applying only a direct current voltage thereto.

17. The image formation method according to claim 13, wherein, in the charging positively the electrophotographic photoreceptor, a charge potential is +600 V or more.

18. An image formation device comprising an electrophotographic photoreceptor and a contact charging system, wherein the electrophotographic photoreceptor comprises: an over coat layer containing a cured product formed by curing a curable compound; and a charge generating material in a photosensitive layer in contact with the over coat layer.
